(19) United States
(12) Patent Application Publication
(10) Pub. No.: US 2024/0022405 A1
(43) Pub. Date: Jan. 18, 2024

(54) HARDWARE ENFORCED SECURITY FOR SERVICE MESH

(71) Applicant: Intel Corporation, Santa Clara, CA (US)

(72) Inventors: Kapil Sood, Washougal, WA (US); Shaojun Ding, Bellevue, WA (US); Dong Guo, Kunshan City (CN); Huailong Zhang, Beijing (CN); Ruijing Guo, Shanghai (CN); Hejie Xu, Beijing (CN); Qiming Liu, Wuxi City (CN)

(21) Appl. No.: 18/477,370

(22) Filed: Sep. 28, 2023

Related U.S. Application Data
(63) Continuation-in-part of application No. PCT/CN2023/098861, filed on Jun. 7, 2023.

(30) Foreign Application Priority Data
Jun. 7, 2023 (WO) PCT/CN2023/098861

(51) Int. Cl. H04L 9/30; H04L 9/08; H04L 9/40

(52) U.S. Cl. CPC H04L 9/3073; H04L 9/0894; H04L 63/0281

(57) ABSTRACT

Systems, apparatus, articles of manufacture, and methods are disclosed to provide hardware enforced security for a service mesh. An example first server of a service mesh disclosed herein to provide hardware enforced security for a service mesh includes programmable circuitry to at least one of instantiate or execute the machine-readable instructions to detect a second server of the service mesh, cause a public key of the second server to be stored in the first enclave, and after an attestation for a second enclave is obtained, cause addition of the second server to the service mesh.

### RELATED APPLICATION

This patent arises from the national stage of International Application No. PCT/CN2023/098861, which was filed on Jun. 7, 2023. International Application No. PCT/CN2023/098861, is hereby incorporated herein by reference in its entirety. Priority to International Application No. PCT/CN2023/098861 is hereby claimed.

### FIELD OF THE DISCLOSURE

This disclosure relates generally to networks and, more particularly, to hardware enforced security for service mesh.

### BACKGROUND

In recent years, cloud native programming has been rapidly emerging for service deployment paradigms. Cloud native programming is a software approach of building, deploying, and managing modern applications in cloud computing environments. Modern applications are usually designed as distributed collections of microservices, with each group of microservices performing some discrete business function. A service mesh is a software infrastructure layer that is added to applications to facilitate service-to-service communications between services or microservices. A service mesh includes a data plane, and a control plane. The data plane supports communication among services. A service mesh may utilize a proxy to route network traffic for an application. For example, a proxy may be deployed along with each service that is initiated. The proxy is abstracted away from the applications and manages the network communications of the application in the service mesh. The control plane takes the user's desired configuration, and dynamically programs the proxy servers, updating the proxy servers as the rules or the environment changes. A service mesh also includes gateways at the edge of the service mesh receiving incoming or outgoing HTTP/TCP connections. The gateway has an entry point that provides incoming traffic management for applications running within the service mesh. The gateway also has an exit point that provides outgoing traffic management for the service mesh.

### BRIEF DESCRIPTION OF THE DRAWINGS

FIGS. 1A and 1B illustrate a block diagram of an example environment in which example servers operate to provide security for service mesh gateways in multi-tenant edge deployments.

FIG. 2 is a block diagram of an example implementation of the example first server of FIG. 1A.

FIG. 3 is a block diagram of an example implementation of the example second server of FIG. 1B.

FIG. 4 is a flowchart representative of example machine readable instructions and/or example operations that may be executed, instantiated, and/or performed by example programmable circuitry to implement the example first server of FIG. 2.

FIG. 5 is a flowchart representative of example machine readable instructions and/or example operations that may be executed, instantiated, and/or performed by example programmable circuitry to implement the example second server of FIG. 3.

FIG. 6 is a flowchart representative of example machine readable instructions and/or example operations that may be executed, instantiated, and/or performed by example programmable circuitry to implement the example first server of FIG. 2 to synchronize a private key from the first server to the second server.

FIG. 7 is a flowchart representative of example machine readable instructions and/or example operations that may be executed, instantiated, and/or performed by example programmable circuitry to implement the example second server of FIG. 3 to synchronize a private key from the first server to the second server.

FIG. 8 is a flowchart representative of example machine readable instructions and/or example operations that may be executed, instantiated, and/or performed by example programmable circuitry to implement the example second server of FIG. 3 to deliver a private key from the second server to a gateway proxy.

FIG. 9 is a flowchart representative of example machine readable instructions and/or example operations that may be executed, instantiated, and/or performed by example programmable circuitry to implement the example second server of FIG. 3 to generate a private key locally.

FIG. 10 is an interaction diagram of an example workflow to implement the example first server of FIGS. 1A and 2, to upload keys to the first server from an administrator.

FIG. 11 is an interaction diagram of an example workflow to implement the example first server of FIGS. 1A, and 2 and the example second server of FIGS. 1B, and 3 to sync keys from the first server to the second server.

FIG. 12 is an interaction diagram of an example workflow to implement the example second server of FIGS. 1 and 3 to deliver keys from the second server to a gateway proxy.

FIG. 13 is a block diagram illustrating the example first server of FIGS. 1A, and 2 for use with a cloud hardware security module adapter, according to some implementations.

FIG. 14 is a block diagram illustrating the example first server of FIG. 2 in a multi-tenant 5G control plane deployment using secured gateways with the example second server of FIG. 3, according to some implementations.

FIG. 15 is a block diagram of an example processing platform including programmable circuitry structured to execute, instantiate, and/or perform the example machine readable instructions and/or perform the example operations of FIGS. 4 and 6 to implement the first server of FIG. 2.

FIG. 16 is a block diagram of an example processing platform including programmable circuitry structured to execute, instantiate, and/or perform the example machine readable instructions and/or perform the example operations of FIGS. 5, 7-9 to implement the second server of FIG. 3.

FIG. 17 is a block diagram of an example implementation of the programmable circuitry of FIG. 15.

FIG. 18 is a block diagram of another example implementation of the programmable circuitry of FIG. 15.

FIG. 19 is a block diagram of an example software/firmware/instructions distribution platform (e.g., one or more servers) to distribute software, instructions, and/or firmware (e.g., corresponding to the example machine readable instructions of FIGS. 4-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

A service mesh approach can be applied to a microservice-based system to manage networked communication among services. Some service mesh implementations utilize gateways to manage incoming and outgoing traffic to the service mesh. A service mesh may include entry points (e.g., an Ingress) and/or exit points (e.g., an Egress). The entry and exit gateways provide services to multiple tenants that access services offered by the system. These entry and exit points may be scalable to meet the demands of incoming traffic. In some examples, the gateway may be implemented using proxy (e.g., an ENVOY proxy). A proxy may operate as a communication bus for large microservice service mesh architectures and may provide fine-grained control over traffic entering and leaving the service mesh.

Tenants of a service mesh access services of the service mesh through cloud native Application Programming Interfaces (APIs). The entry and exit gateway are sensitive control points which secure the entry into the service mesh. Typically, users perform Transport Layer Security (TLS) termination for inbound traffic, and TLS origination for outbound traffic in gateways. For example, a gateway may be secured for TLS handshake with private keys and certificates bound to the gateway.

Methods and apparatus disclosed herein improve the security structure of a service mesh by combining confidential computing with cloud native service mesh. The combination creates an Information Architecture (IA) friendly software design that, in some examples, enables use of confidential computing technologies through open source. Confidential computing is a cloud computing technology that isolates sensitive data in a protected central processing unit (CPU) enclave or memory during processing. This hardware-enforced security mechanism offers protection to sensitive data (e.g., private keys). Methods and apparatus disclosed herein provide such hardware-enforced security mechanisms for securing a gateway and/or proxy elements of a service mesh. The hardware-enforced security mechanism ensures private keys are not exposed in clear text in a distributed, third party hosted environments like Communication Service Provider (CoSP) Edge, Secure Edge Service Access (SASE), Enterprise Edge, etc.

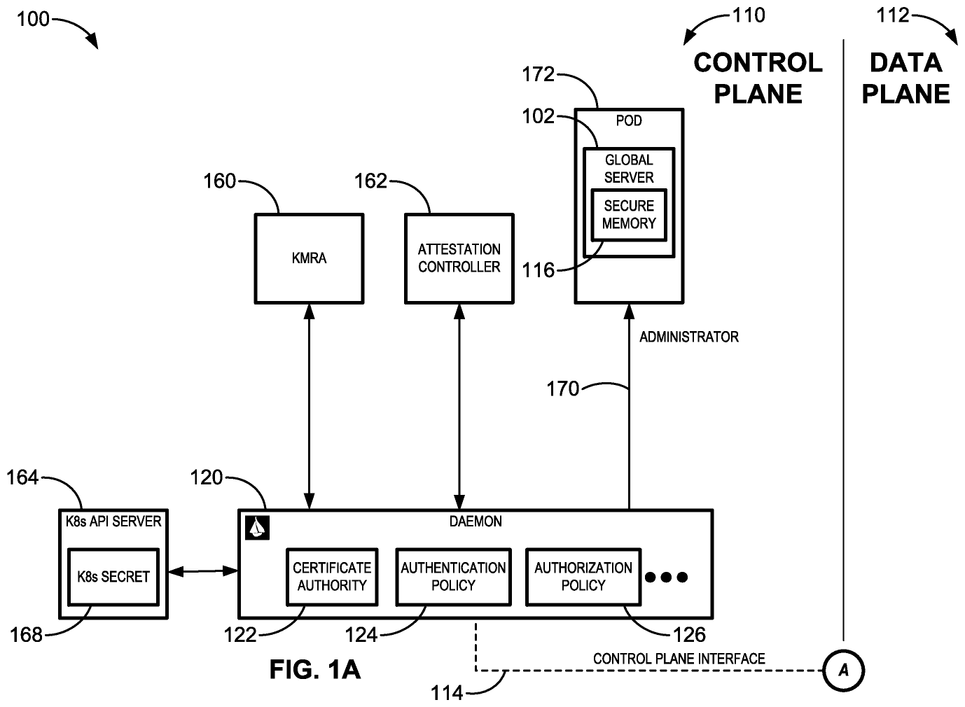

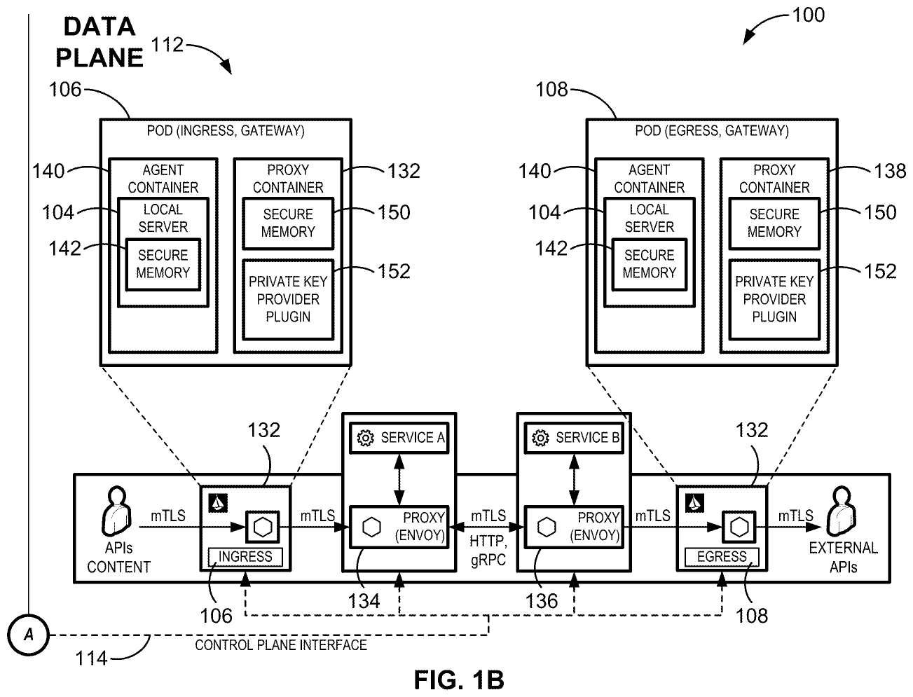

FIGS. 1A and 1B is a block diagram of an example environment 100 in which an example first server or global server 102 and second server or local server 104 operate to protect the keys in the ingress gateway circuitry 106 and egress gateway circuitry 108. The example environment 100 includes an example control plane circuitry 110 to manage and configure proxy circuitries 132-138 to route traffic, and an example data plane circuitry 112 which includes set of intelligent proxies 132-138 (e.g., Envoy) deployed as sidecars and their interactions. The example environment 100 further includes an example control plane interface 114 that is shared between the control plane circuitry 110 and the data plane circuitry 112 for communications therebetween.

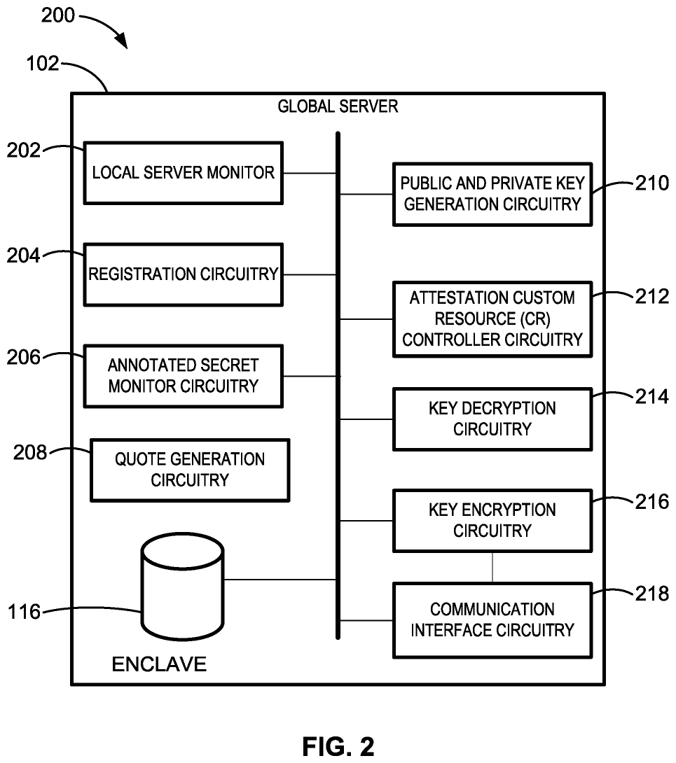

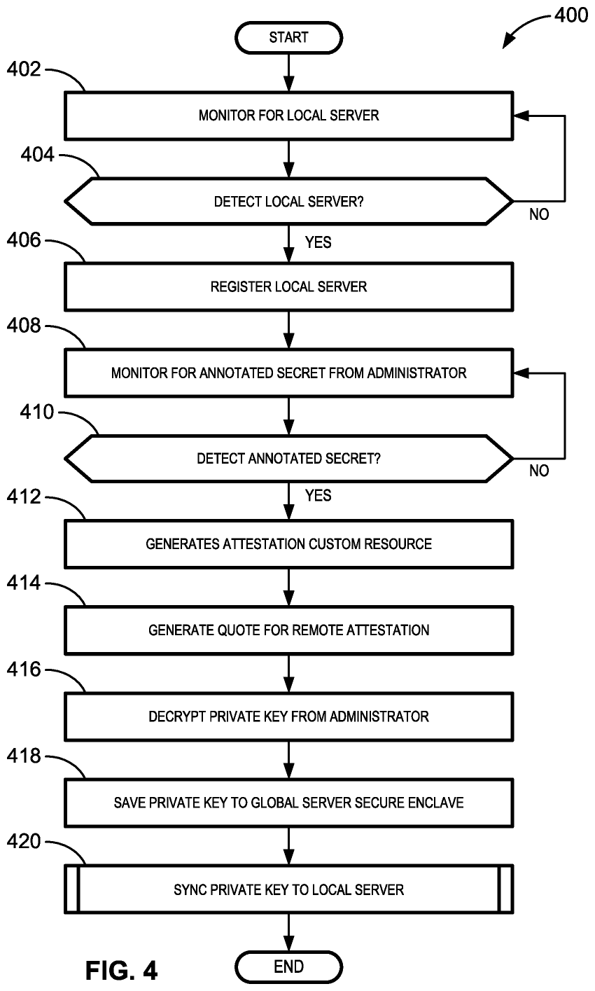

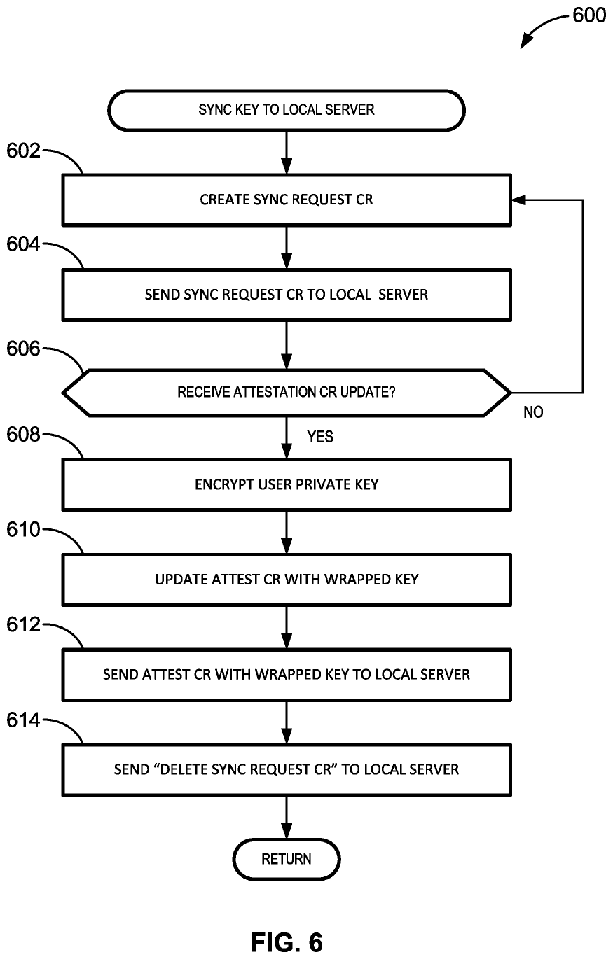

The example control plane circuitry 110 includes the global server 102 to protect and/or secure a user private key in a global server secure memory 116 (e.g., a secure enclave, a trusted platform module (TPM), etc.). The user private key received from an administrator 170. The example global server 102 is described in more detail below in connection with FIG. 2, FIG. 4, and FIG. 6. The example control plane circuitry 110 also includes a daemon 120 (e.g., an ISTIO® daemon (istiod)), a computer program that runs as a background process to unify service mesh functionality such as service discovery, configuration, and certificate generation. The daemon 120 includes a certificate authority 122 to manage keys and certificate, an authentication policy 124 to verify the identity of a user, and an authorization policy 126 to determine what information a client can access. The control plane circuitry 110 configures the service mesh authentication and authorization settings, correctly route traffic from a proxy to a service, specify settings on proxy, etc.

The example data plane circuitry 112 includes a set of intelligent proxies 132, 134, 136, and 138 deployed as sidecars. These example proxies mediate and control all network communication between microservices. The example data plane circuitry 112 includes the example ingress gateway circuitry 106 to route incoming traffic to the service mesh, and the example egress gateway circuitry 108 to route outgoing traffic from the service mesh. The ingress gateway circuitry 106 includes an agent 140 (e.g., ISTIOCLagent) that acts as an intermediate proxy between the daemon 120 and proxy 132. The example agent 140 helps each sidecar connect to the service mesh by securely passing configuration and secrets to the proxy 132. While the agent 140 is considered part of the control plane circuitry 110, it runs on a per-pod basis.

A pod is a group of one or more containers with shared storage and network, and a specification for how to run the containers. Pods are workload instances in a container-centric management software (e.g., KUBERNETES®) deployment of service mesh (e.g., ISTIO®, KONG® Konnect, HASHICORP CONSUL®, AWS® App Mesh, etc.). The container-centric management software deploys and operates containerized applications in the service mesh's control plane circuitry 110.

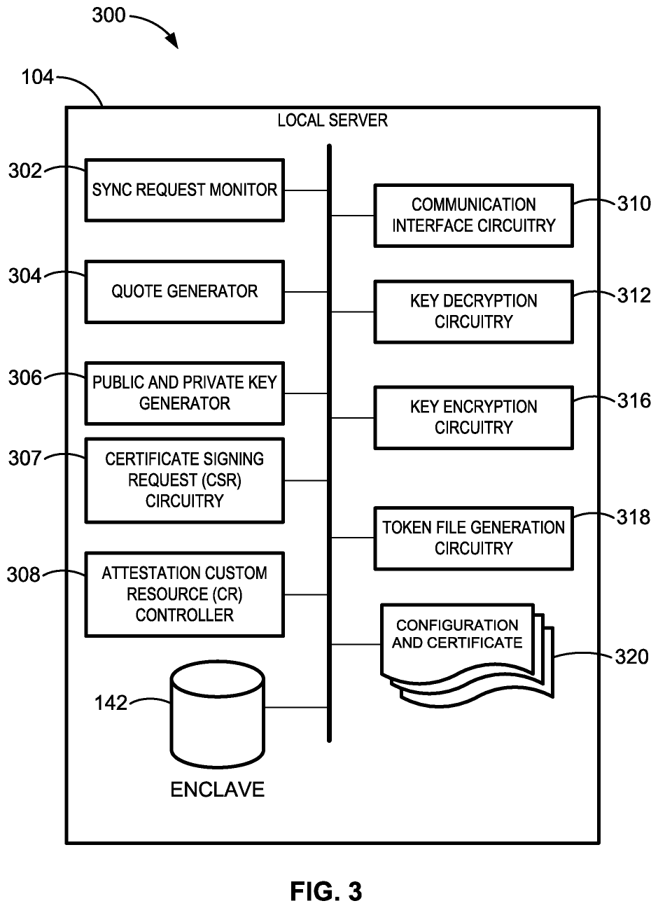

The example agent 140 includes the local server 104 to protect public and private key pairs in the local server secure memory 142. The example local server 104 is described in more detail below in connection with FIGS. 3, 5, 7-9. The example proxy 132 includes a proxy secure memory 150 to store the public and private key pairs and a private key provider plugin 152 may utilize the private key in the proxy secure memory 150 to perform encryption and decryption operations in the data plane circuitry 112.

FIG. 2 is a block diagram of an example implementation of the first server 102 of FIG. 1A to detect and register a second server 104 of FIG. 1B and to enable the first server 102 to securely synchronize key pairs to the second server 104 utilizing a hardware-enforced security mechanism. The example first server 102 is a credential server (e.g., secret discovery service (SDS) server, global SDS server). For example, the credential server may implement the GOOGLE® Remote Procedure Call (gRPC) service. The gRPC service allows client and server applications to communicate transparently and develop connected systems. In some examples, the first server 102 could be another type of server. The example first server 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the example first server 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example first server 102 of FIG. 2 includes an example local server monitor circuitry 202, an example registration circuitry 204, an example annotated secret monitor circuitry 206, an example quote generation circuitry 208, an example public and private key generation circuitry 210, an example attestation custom resource (CR) controller circuitry 212, an example key decryption circuitry 214, an example key encryption circuitry 216, an example communication interface circuitry 218 and an example enclave 116. The example enclave 116 stores private keys from the administrator 170 (FIG. 1A).

The example first server or global server 102 of FIG. 2 is provided with the example local server monitor circuitry 202 to monitor for a local server or the second server 104 (FIG. 1B) in the data plane circuitry 112 (FIG. 1B). The global server 102 monitors for a broadcast message and receives a broadcast message from the local server 104 when the local server 104 is launched. When the global server 102 receives the broadcast message from the local server 104, it determines that a local server 104 is present.

In the illustrated example, the registration circuitry 204 registers the detected local server 104 to the global server 102. Registering the local server 104 allows the global server 102 to synchronize private key to the local server 104 when the global server 102 receives a private key from an administrator 170. The administrator 170 obtains the private key from a user who wants to access microservices in the service mesh system.

The example first server 102 of FIG. 2 includes the example annotated secret monitor 206 to monitor for an annotated secret. An annotated secret is an object that contains sensitive data such as a key, a password or a token that has been annotated with a special flag. In the illustrated example, the annotated secret is a KUBERNETES® secret which carries private key ID, certificate chain and/or CA certificate. The administrator 170 (FIG. 1A) annotates the secret with a special flag, for example “Intel-SGX”. The annotated secret monitor circuitry 206 monitors for the annotated secret.

If an annotated secret is detected, the example quote generation circuitry 208 generates a quote for remote attestation. Remote attestation is performed to ensure that two enclaves can collaborate securely, such as performing data exchange, communicate to conduct specific services, etc. When a global server 102 with a secure enclave 116 (FIG. 1A) receives secret from an administrator 170, the global server 102 may prove to the administrator 170 that the global server 102 is running on a trusted platform that can process the secrets securely. The process of proving a secure execution environment is sometimes referred to as attestation. A quote is a platform unique asymmetric attestation key, which represents a digitally signed attestation generated through a hardware and software configuration of a particular enclave. A quote is a proof of the trustworthiness of the enclave.

The example public and private key generation circuitry 210 generates a public and private key pair. A remote party utilizes a public key to verify the quote. A private key is utilized to sign a secure enclave 116.

The example attestation custom resource (CR) controller 212 creates an attestation custom resource. For example, a custom resource may be an extension of the K8 API. The attestation custom resource is utilized in the remote attestation of the global server 102 to store and retrieve structured data related to the remote attestation.

The example first server 102 of FIG. 2 includes the example key decryption circuitry 214 to decrypt the user private key from the administrator 170. While the decryption circuitry 214 of the illustrated example applies a decryption algorithm, the decryption circuitry 214 may additionally or alternatively unwrap the user private key and/or apply any other type of algorithm to access the user private key. The decrypted user private key is saved into the global server secure enclave 116.

The example key encryption circuitry 216 encrypts the user private key. The encrypted user private key is synchronized to the local server 104. While the encryption circuitry 216 of the illustrated example applies an encryption algorithm, the encryption circuitry 216 may additionally or alternatively wrap the user private key and/or apply any other type of algorithm to wrap the user private key.

The example communication interface circuitry 218 performs the communication between the global server 102 and local server 104. The global server 102 creates a custom resource associated with a synchronization request. The example communication interface circuitry 218 sends the synchronization request CR to the local server 104 prior to synchronizing the user private key to the local server 104.

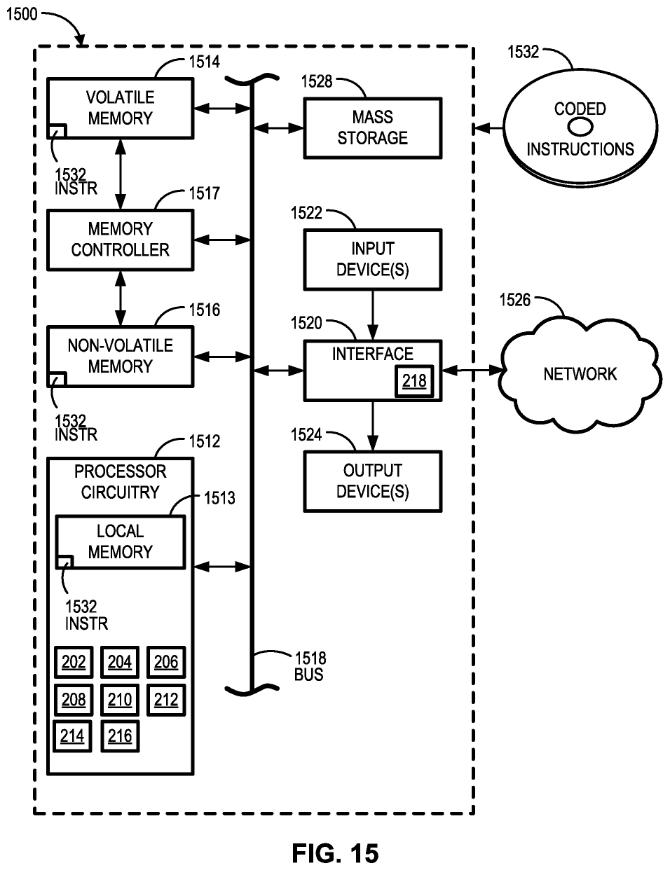

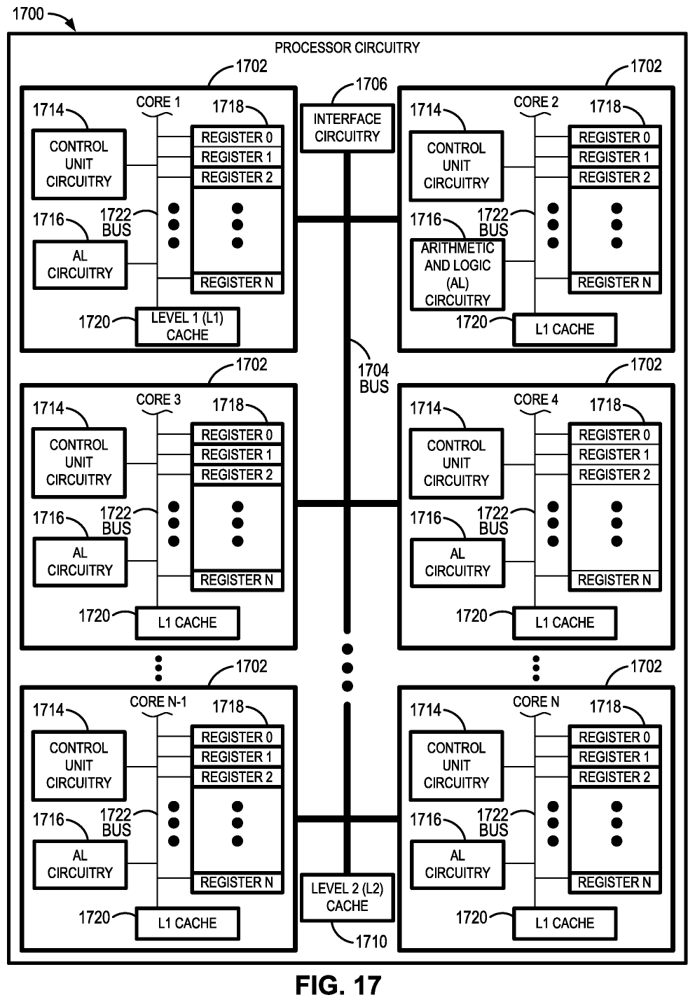

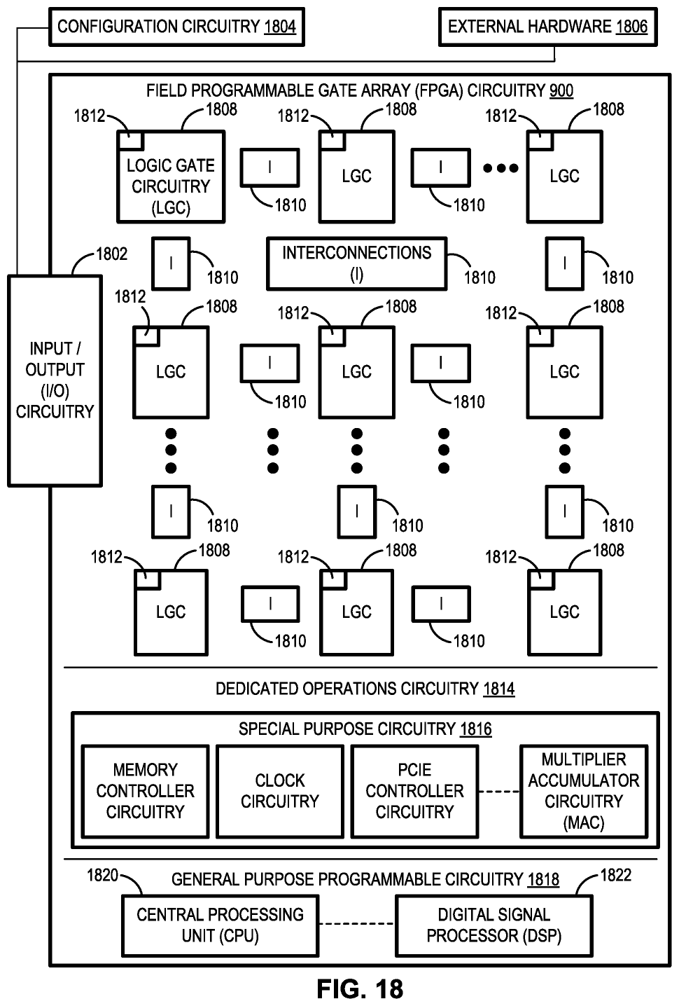

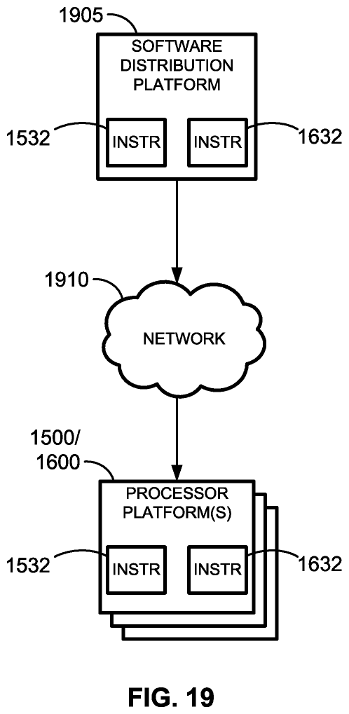

In some examples, the first server 102 includes means for monitoring for a local server. For example, the means for monitoring may be implemented by local server monitor circuitry 202. In some examples, the local server monitor circuitry 202 may be instantiated by programmable circuitry such as the example programmable circuitry 1512 of FIG. 15. For instance, the local server monitor circuitry 202 may be instantiated by the example microprocessor 1700 of FIG. 17 executing machine executable instructions such as those implemented by at least blocks 402, 404 of FIG. 4. In some examples, the local server monitor circuitry 202 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the local server monitor circuitry 202 may be instantiated by any other combination of hardware, software, and/or firmware. For example, the local server monitor circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for registering a server. For example, the means for registering may be implemented by registration circuitry 204. In some examples, the registration circuitry 204 may be instantiated by programmable circuitry such as the example programmable circuitry 1512 of FIG. 15. For instance, the registration circuitry 204 may be instantiated by the example microprocessor 1700 of FIG. 17 executing machine executable instructions such as those implemented by at least blocks 406 of FIG. 4. In some examples, registration circuitry 204 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the registration circuitry 204 may be instantiated by any other combination of hardware, software, and/or firmware. For example, the registration circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for monitoring. For example, the means for monitoring may be implemented by annotated secret monitor circuitry 206. In some examples, the annotated secret monitor circuitry 206 may be instantiated by programmable circuitry such as the example programmable circuitry 1512 of FIG. 15. For instance, the annotated secret monitor circuitry 206 may be instantiated by the example microprocessor 1700 of FIG. 17 executing machine executable instructions such as those implemented by at least blocks 408 of FIG. 4. In some examples, the annotated secret monitor circuitry 206 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the annotated secret monitor circuitry 206 may be instantiated by any other combination of hardware, software, and/or firmware. For example, the annotated secret monitor circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for generating a quote. For example, the means for generating a quote may be implemented by quote generation circuitry 208. In some examples, the quote generation circuitry 208 may be instantiated by programmable circuitry such as the example programmable circuitry 1512 of FIG. 15. For instance, the quote generation circuitry 208 may be instantiated by the example microprocessor 1700 of FIG. 17 executing machine executable instructions such as those implemented by at least blocks 414 of FIG. 4. In some examples, the quote generation circuitry 208 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the quote generation circuitry 208 may be instantiated by any other combination of hardware, software, and/or firmware. For example, the quote generation circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for generating a key pair. For example, the means for generating a key pair may be implemented by public and private key generation circuitry 210. In some examples, the public and private key generation circuitry 210 may be instantiated by programmable circuitry such as the example programmable circuitry 1512 of FIG. 15. For instance, the public and private key generation circuitry 210 may be instantiated by the example microprocessor 1700 of FIG. 17 executing machine executable instructions such as those implemented by at least blocks 414 of FIG. 4. In some examples, the public and private key generation circuitry 210 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the public and private key generation circuitry 210 may be instantiated by any other combination of hardware, software, and/or firmware. For example, the public and private key generation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for generating an attestation CR. For example, the means for generating an attestation CR may be implemented by attestation custom resource (CR) controller circuitry 212. In some examples, the attestation CR controller circuitry 212 may be instantiated by programmable circuitry such as the example programmable circuitry 1512 of FIG. 15. For instance, the attestation CR controller circuitry 212 may be instantiated by the example microprocessor 1700 of FIG. 17 executing machine executable instructions such as those implemented by at least blocks 412 of FIG. 4. In some examples, the attestation CR controller circuitry 212 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the attestation CR controller circuitry 212 may be instantiated by any other combination of hardware, software, and/or firmware. For example, the attestation CR controller circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for decrypting. For example, the means for decrypting may be implemented by key decryption circuitry 214. In some examples, the key decryption circuitry 214 may be instantiated by programmable circuitry such as the example programmable circuitry 1512 of FIG. 15. For instance, the key decryption circuitry 214 may be instantiated by the example microprocessor 1700 of FIG. 17 executing machine executable instructions such as those implemented by at least blocks 416 of FIG. 4. In some examples, the key decryption circuitry 214 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the key decryption circuitry 214 may be instantiated by any other combination of hardware, software, and/or firmware. For example, the key decryption circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for encrypting. For example, the means for encrypting may be implemented by key encryption circuitry 216. In some examples, the key encryption circuitry 216 may be instantiated by programmable circuitry such as the example programmable circuitry 1512 of FIG. 15. For instance, the key encryption circuitry 216 may be instantiated by the example microprocessor 1700 of FIG. 17 executing machine executable instructions such as those implemented by at least blocks 608 of FIG. 6. In some examples, the key encryption circuitry 216 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the key encryption circuitry 216 may be instantiated by any other combination of hardware, software, and/or firmware. For example, the key encryption circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the first server 102 includes means for sending a synchronization request. For example, the means for sending a synchronization request may be implemented by communication interface circuitry 218. In some examples, the communication interface circuitry 218 may be instantiated by programmable circuitry such as the example programmable circuitry 1512 of FIG. 15. For instance, the communication interface circuitry 218 may be instantiated by the example microprocessor 1700 of FIG. 17 executing machine executable instructions such as those implemented by at least blocks 604, 612 of FIG. 6. In some examples, the communication interface circuitry 218 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the communication interface circuitry 218 may be instantiated by any other combination of hardware, software, and/or firmware. For example, the communication interface circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the first server 102 of FIG. 1A is illustrated in FIG. 2, one or more of the elements, processes, and/or devices illustrated in FIG. 2 may be combined, divided, re-arranged, omitted, eliminated, and/or implemented in any other way. Further, the example local server monitor circuitry 202, the example registration circuitry 204, the example annotated secret monitor circuitry 206, the example quote generation circuitry 208, the example public and private key generation circuitry 210, the example attestation custom resource (CR) controller circuitry 212, the example key decryption circuitry 214, the example key encryption circuitry 216, the example communication interface circuitry 218 and/or, more generally, the example first server 102 of FIG. 2, may be implemented by hardware alone or by hardware in combination with software and/or firmware. Thus, for example, any of the example local server monitor circuitry 202, the example registration circuitry 204, the example annotated secret monitor circuitry 206, the example quote generation circuitry 208, the example public and private key generation circuitry 210, the example attestation custom resource (CR) controller circuitry 212, the example key decryption circuitry 214, the example key encryption circuitry 216, the example communication interface circuitry 218, and/or, more generally, the example first server 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example first server 102 of FIG. 2 may include one or more elements, processes, and/or devices in addition to, or instead of, those illustrated in FIG. 2, and/or may include more than one of any or all of the illustrated elements, processes and devices.

FIG. 3 is a block diagram of an example implementation of the second server or local server 104 of FIG. 1B to synchronize the user private key from the first server 102 of FIG. 1A and deliver the user private key to a gateway proxy 132 (FIG. 1B). The example second server 104 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the example second server 104 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or at different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example second server 104 of FIG. 3 includes an example sync request monitor circuitry 302, an example quote generation circuitry 304, an example public and private key generation circuitry 306, an example certificate signing request (CSR) circuitry 307, an example attestation custom resource (CR) controller circuitry 308, an example communication interface circuitry 310, an example key decryption circuitry 312, an example enclave 142, an example key encryption circuitry 316, and an example token file generation circuitry 318. The example enclave 142 is utilized to store private keys from the first server 102 (FIG. 1A).

The example second server or local server 104 of FIG. 3 is provided with the example sync request monitor circuitry 302 to monitor for a synchronization request (syncReq) from the first server or global server 102. When a new user private key is uploaded to the global server 102, it triggers the global server 102 to send a syncReq to each of the local server 104 registered with the global server 102. The global server 102 creates a syncReq custom resource (CR) and sends it to the local server 104. The example sync request monitor circuitry 302 monitors for the corresponding syncReq CR. If a syncReq CR is detected, the local server 104 creates another CR associated with attestation.

The example quote generation circuitry 304 generates a quote for remote attestation. Remote attestation is performed to ensure that two enclaves can collaborate securely, such as performing data exchange, communicate to conduct specific services, etc. When a global server 102 with a secure enclave 116 (FIG. 1A) wants to synchronize a user private key to the local server 104, the local server 104 has to prove to the global server 102 that the local server 104 is running on a trusted platform that can process the private key or secret securely. To ensure that the enclave 116 is safe and trusted, the enclave provides evidence which is called a quote. A quote is a unique asymmetric attestation key, which represents a digitally signed attestation generated through a hardware and software configuration of a particular enclave. The process to verify the quote is called a remote attestation. Thus, the quote generation circuitry 304 of the local server 104 generates a quote to prove the trustworthiness of the enclave.

The example certificate signing request (CSR) circuitry 307 generates a CSR. A CSR is a message sent from an applicant to a certificate authority (CA) 122 (FIG. 1A) of the public key infrastructure in order to apply for a digital identity certificate. In the illustrated example, the local server 104 sends the CSR to the CA to create a certificate for the local server 104 to encrypt traffic to the local server 104. The CSR circuitry 307 encodes the quote into the CSR. The CA will sign the CSR only if the quote attestation has passed. The signed certificate is sent to the local server 104.

The example public and private key generation circuitry 306 generates a public and private key pair used in the remote attestation process. A remote party utilizes a public key to verify the quote. In the illustrated example, the remote party is an attestation controller 162 (FIG. 1A) that verifies the quote from the local server 104. A private key is utilized to sign the local server secure enclave 142 (FIG. 1B).

The example attestation custom resource (CR) controller circuitry 308 creates an attestation CR to be sent to an attestation controller 162 to verify the quote. The attestation CR is utilized in the remote attestation of the local server 104 to store and retrieve structured data related to the remote attestation process.

The example second server or local server 104 of FIG. 3 includes a communication interface circuitry 310 to enable the local server 104 to communicate with the first server or global server 102 and the gateway proxy 132 (FIG. 1B). The example communication interface circuitry 310 receives updated attestation CR from the attestation controller 162 and a wrapped user private key from the global server 102. The communication interface circuitry 310 is also utilized to send the wrapped user private key from the local server 104 to the gateway proxy 132.

The example local server 104 of FIG. 3 is provided with the key decryption circuitry 312 to decrypt the encrypted user private key received from the global server 102. While the decryption circuitry 312 of the illustrated example applies a decryption algorithm, the decryption circuitry 312 may additionally or alternatively unwrap the user private key and/or apply any other type of algorithm to access the user private key. The decrypted user private key is saved in the secure enclave 142.

The example second server 104 of FIG. 3 includes the example key encryption circuitry 316 to encrypt the user private key before synchronizing the user private key to a gateway proxy 132. While the encryption circuitry 316 of the illustrated example applies an encryption algorithm, the encryption circuitry 316 may additionally or alternatively wrap the user private key and/or apply any other type of algorithm to wrap the user private key.

The example token file generation circuitry 318 is utilized to safely transport the user private key from the local server 104 to the gateway proxy 132. In the illustrated example, the token file generation circuitry 318 is a crypto API toolkit (CTK). The token file generation circuitry 318 generates a token file which is shared between the local server 104 and the gateway proxy 132. The local server 104 utilizes the CTK with the secure enclave 142 to enhance the security of data and key protection application by exposing interfaces that run the key generation and cryptographic operations securely inside the secure enclave 142. When a proxy 132 is launched, it bootstraps the proxy secure enclave 150 with the same token files utilized by the local server secure enclave 142. When the proxy 132 needs a new secret, it will send a standard SDS request to the local server 104. The local server 104 sends an SDS response to the proxy 132. The SDS response includes the final certificate and configuration about the secure enclave private key provider plugin. When the proxy 132 receives the SDS response, it creates the secure enclave private key provider plugin object 152. Then, the secure enclave private key provider plugin 152 will find the secure enclave 150 created by the secure enclave bootstrap extension when it first launched. Leveraging the shared CTK token file, the local server 104 is able to send the corresponding user private key configuration information and the signed certificate 320 to the gateway proxy 132. The gateway proxy 132 saves the final certificate 320 and the private key in the secure enclave 150. The secure enclave private key provider plugin 152 utilizes the private key in the secure enclave 150 to perform the sign( )/decrypt( ) operation in the data plane.

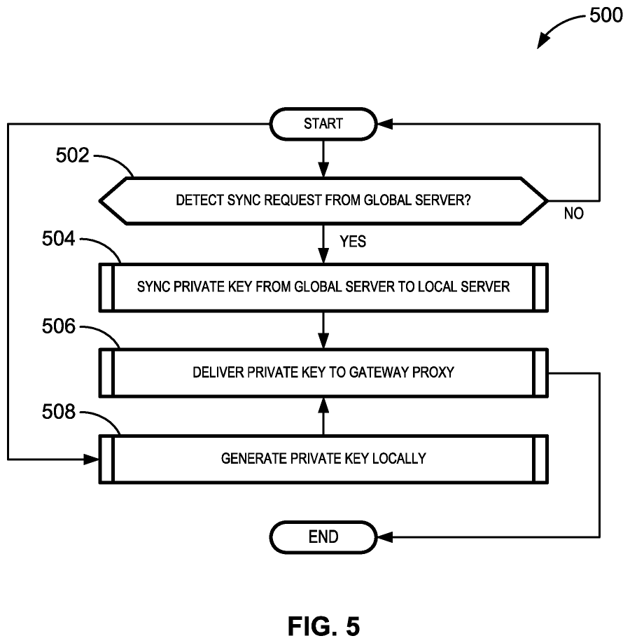

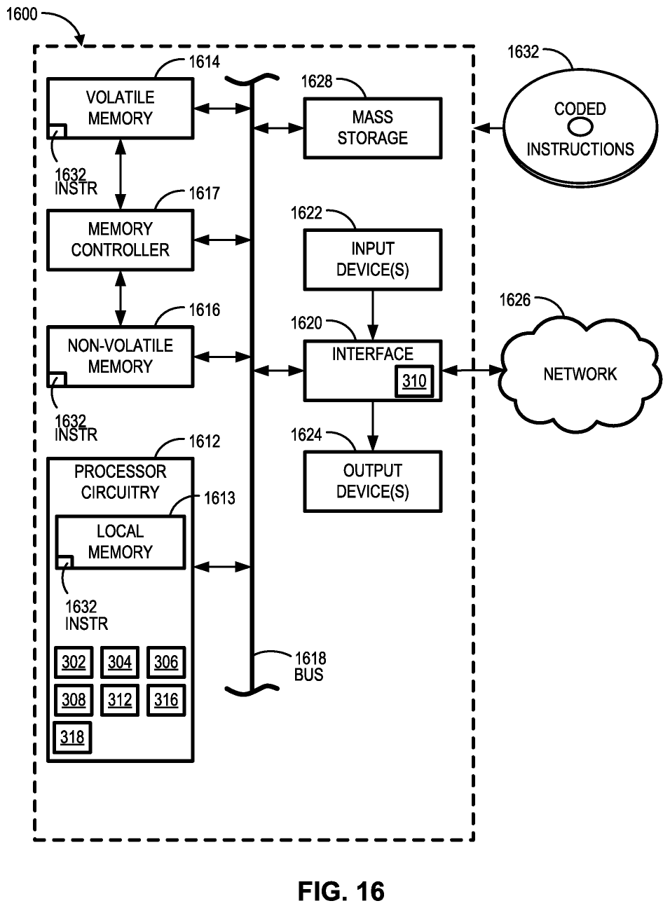

In some examples, the second server 104 includes means for monitoring. For example, the means for monitoring may be implemented by sync request monitor circuitry 302. In some examples, the sync request monitor circuitry 302 may be instantiated by programmable circuitry such as the example programmable circuitry 1612 of FIG. 16. For instance, the sync request monitor circuitry 302 may be instantiated by the example microprocessor 1700 of FIG. 17 executing machine executable instructions such as those implemented by at least blocks 502 of FIG. 5. In some examples, the sync request monitor circuitry 302 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the sync request monitor circuitry 302 may be instantiated by any other combination of hardware, software, and/or firmware. For example, the sync request monitor circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

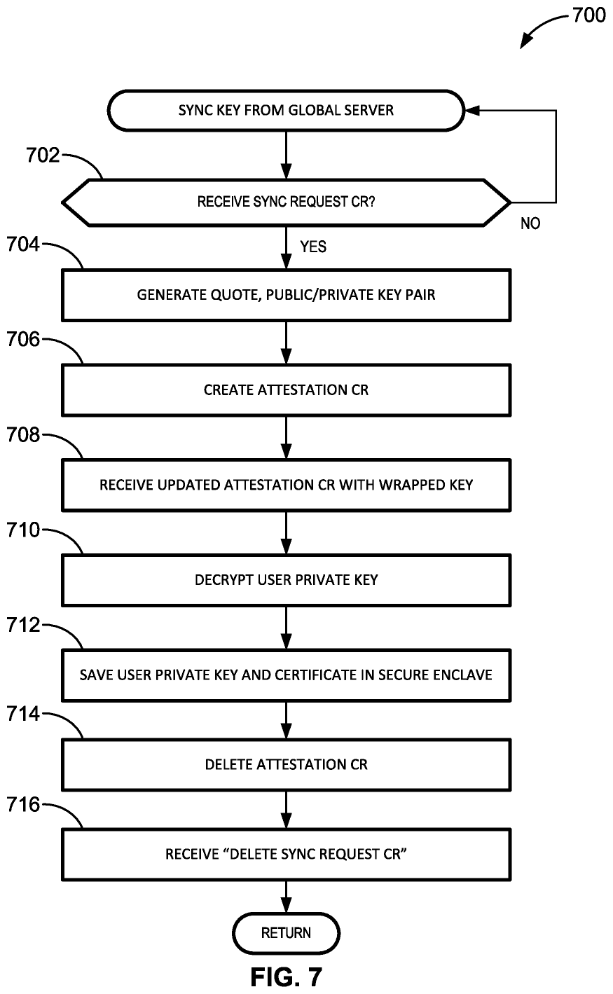

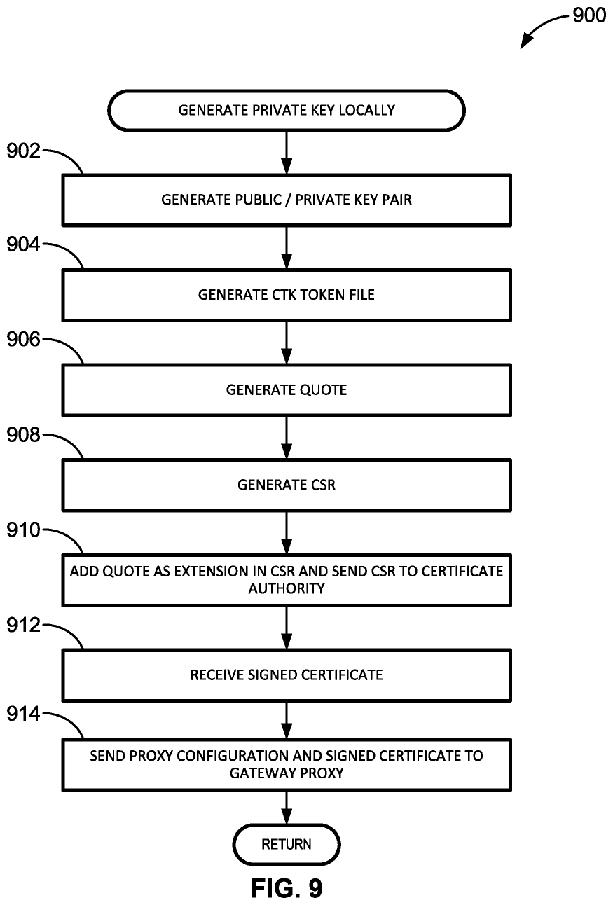

In some examples, the second server 104 includes means for generating a quote. For example, the means for generating a quote may be implemented by quote generation circuitry 304. In some examples, the quote generation circuitry 304 may be instantiated by programmable circuitry such as the example programmable circuitry 1612 of FIG. 16. For instance, the quote generation circuitry 304 may be instantiated by the example microprocessor 1700 of FIG. 17 executing machine executable instructions such as those implemented by at least blocks 704 of FIG. 7 and 906 of FIG. 9. In some examples, the quote generation circuitry 304 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the quote generation circuitry 304 may be instantiated by any other combination of hardware, software, and/or firmware. For example, the quote generation circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the second server 104 includes means for generating a key pair. For example, the means for generating a key pair may be implemented by public and private key generation circuitry 306. In some examples, the public and private key generation circuitry 306 may be instantiated by programmable circuitry such as the example programmable circuitry 1612 of FIG. 16. For instance, the public and private key generation circuitry 306 may be instantiated by the example microprocessor 1700 of FIG. 17 executing machine executable instructions such as those implemented by at least blocks 704 of FIG. 7 and 902 of FIG. 9. In some examples, the public and private key generation circuitry 306 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the public and private key generation circuitry 306 may be instantiated by any other combination of hardware, software, and/or firmware. For example, the public and private key generation circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

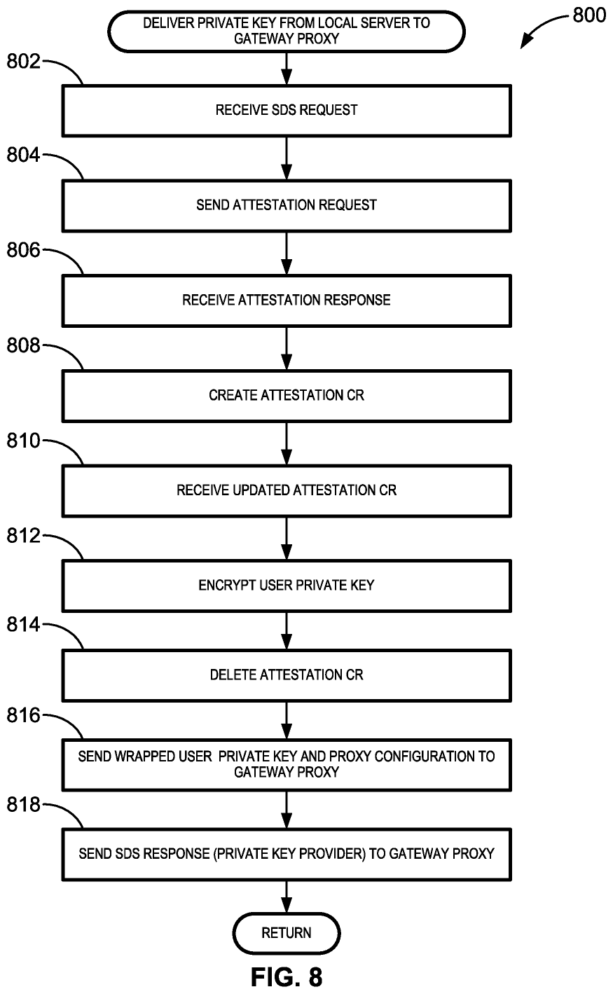

In some examples, the second server 104 includes means for creating an attestation CR. For example, the means for creating an attestation CR may be implemented by attestation custom resource (CR) controller circuitry 308. In some examples, the attestation CR controller circuitry 308 may be instantiated by programmable circuitry such as the example programmable circuitry 1612 of FIG. 16. For instance, the attestation CR controller circuitry 308 may be instantiated by the example microprocessor 1700 of FIG. 17 executing machine executable instructions such as those implemented by at least blocks 706 of FIG. 7, and 808 of FIG. 8. In some examples, the attestation CR controller circuitry 308 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the attestation CR controller circuitry 308 may be instantiated by any other combination of hardware, software, and/or firmware. For example, the attestation CR controller circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the second server 104 includes means for communicating. For example, the means for communicating may be implemented by communication interface circuitry 310. In some examples, the communication interface circuitry 310 may be instantiated by programmable circuitry such as the example programmable circuitry 1612 of FIG. 16. For instance, the communication interface circuitry 310 may be instantiated by the example microprocessor 1700 of FIG. 17 executing machine executable instructions such as those implemented by at least blocks 504, 506 of FIG. 5, 702, 708, 716 of FIG. 7, 802, 804, 806, 812, 816, 818 of FIG. 8 and 912, 914 of FIG. 9. In some examples, the communication interface circuitry 310 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the communication interface circuitry 310 may be instantiated by any other combination of hardware, software, and/or firmware. For example, the communication interface circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the second server 104 includes means for decrypting. For example, the means for decrypting may be implemented by key decryption circuitry 312. In some examples, the key decryption circuitry 312 may be instantiated by programmable circuitry such as the example programmable circuitry 1612 of FIG. 16. For instance, the key decryption circuitry 312 may be instantiated by the example microprocessor 1700 of FIG. 17 executing machine executable instructions such as those implemented by at least blocks 710 of FIG. 7, and 810 of FIG. 8. In some examples, the key decryption circuitry 312 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the key decryption circuitry 312 may be instantiated by any other combination of hardware, software, and/or firmware. For example, the key decryption circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the second server 104 includes means for encrypting. For example, the means for encrypting may be implemented by key encryption circuitry 316. In some examples, the key encryption circuitry 316 may be instantiated by programmable circuitry such as the example programmable circuitry 1612 of FIG. 16. For instance, the key encryption circuitry 316 may be instantiated by the example microprocessor 1700 of FIG. 17 executing machine executable instructions such as those implemented by at least blocks 816 of FIG. 8. In some examples, the key encryption circuitry 316 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the key encryption circuitry 316 may be instantiated by any other combination of hardware, software, and/or firmware. For example, the key encryption circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the second server 104 includes means for generating a token file. For example, the means for generating a token file may be implemented by token file generation circuitry 318. In some examples, the token file generation circuitry 318 may be instantiated by programmable circuitry such as the example programmable circuitry 1612 of FIG. 16. For instance, the token file generation circuitry 318 may be instantiated by the example microprocessor 1700 of FIG. 17 executing machine executable instructions such as those implemented by at least blocks 904 of FIG. 9. In some examples, the token file generation circuitry 318 may be instantiated by hardware logic circuitry, which may be implemented by an ASIC, XPU, or the FPGA circuitry 1800 of FIG. 18 configured and/or structured to perform operations corresponding to the machine readable instructions. Additionally or alternatively, the token file generation circuitry 318 may be instantiated by any other combination of hardware, software, and/or firmware. For example, the token file generation circuitry 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the second server 104 of FIG. 1 is illustrated in FIG. 3, one or more of the elements, processes, and/or devices illustrated in FIG. 3 may be combined, divided, re-arranged, omitted, eliminated, and/or implemented in any other way. Further, the example sync request monitor circuitry 302, the example quote generation circuitry 304, the example public and private key generation circuitry 306, the example certificate signing request (CSR) circuitry 307, the example attestation custom resource (CR) controller circuitry 308, the example communication interface circuitry 310, the example key decryption circuitry 312, the example key encryption circuitry 316, the example token file generation circuitry 318, and/or, more generally, the example second server 104 of FIG. 3, may be implemented by hardware alone or by hardware in combination with software and/or firmware. Thus, for example, any of the example sync request monitor circuitry 302, the example quote generation circuitry 304, the example public and private key generation circuitry 306, the example certificate signing request (CSR) circuitry 307, the example attestation custom resource (CR) controller circuitry 308, the example communication interface circuitry 310, the example key decryption circuitry 312, the example key encryption circuitry 316, the example token file generation circuitry 318, and/or, more generally, the example second server 104, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example second server 104 of FIG. 3 may include one or more elements, processes, and/or devices in addition to, or instead of, those illustrated in FIG. 3, and/or may include more than one of any or all of the illustrated elements, processes, and devices.

Flowcharts representative of example machine readable instructions, which may be executed by programmable circuitry to implement and/or instantiate the first server 102 of FIG. 2 and/or representative of example operations which may be performed by programmable circuitry to implement and/or instantiate the first server of FIG. 2, are shown in FIGS. 4 and 6. The machine readable instructions may be one or more executable programs or portion(s) of one or more executable programs for execution by programmable circuitry such as the programmable circuitry 1512 shown in the example processor platform 1500 discussed below in connection with FIG. 15 and/or may be one or more function(s) or portion(s) of functions to be performed by the example programmable circuitry (e.g., an FPGA) discussed below in connection with FIGS. 17 and/or 18. In some examples, the machine readable instructions cause an operation, a task, etc., to be carried out and/or performed in an automated manner in the real world. As used herein, “automated” means without human involvement.

Flowcharts representative of example machine readable instructions, which may be executed by programmable circuitry to implement and/or instantiate the second server 104 of FIG. 3 and/or representative of example operations which may be performed by programmable circuitry to implement and/or instantiate the second server 104 of FIG. 3, are shown in FIGS. 5, 7-9. The machine readable instructions may be one or more executable programs or portion(s) of one or more executable programs for execution by programmable circuitry such as the programmable circuitry 1612 shown in the example processor platform 1600 discussed below in connection with FIG. 16 and/or may be one or more function(s) or portion(s) of functions to be performed by the example programmable circuitry (e.g., an FPGA) discussed below in connection with FIGS. 17 and/or 18. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-9, many other methods of implementing the example first server 102 and second server 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, and/or activities, the phrase “at least one of A and B” is intended to refer to implementations including any of (1) at least one A, (2) at least one B, or (3) at least one A and at least one B. Similarly, as used herein in the context of describing the performance or execution of processes, instructions, actions, and/or activities, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to synchronize a private key from the first server or global server 102 (FIG. 1A) to the second server or local server 104 (FIG. 1B). The example machine-readable instructions and/or the example operations 400 of FIG. 4 begin at block 402, at which the local server monitor circuitry 202 (FIG. 2) monitors for the local server 104. If the example local server monitor circuitry 202 does not detect the second server 104 (block 404: NO), control advances to block 402, at which the example local server monitor circuitry 202 continues to monitor for the second server 104. If the example local server monitor circuitry 202 detects the second server 104 (block 404: YES), control advances to block 406, at which the example registration circuitry 204 (FIG. 2) registers the detected second server 104 of environment 100. The example annotated secret monitor 206 (FIG. 2) monitors for an annotated secret from the administrator 170 (FIG. 1A) (block 408). If the example annotated secret monitor circuitry 206 does not detect an annotated secret (block 410: NO), control advances to block 408, at which the example annotated secret monitor circuitry 206 continues to monitor for the annotated secret. If the example annotated secret monitor circuitry 206 detects an annotated secret (block 410: YES), control advances to block 412, at which the example attestation custom resource (CR) controller circuitry 212 (FIG. 2) generates an attestation custom resource (CR) (block 412). At block 414, the example quote generation circuitry 208 (FIG. 2) generates a quote for remote attestation. At block 416, the key decryption circuitry 214 decrypts or unwraps the user private key from the administrator 170. At block 418, the private key is saved to the first server secure enclave 116 (FIG. 1A). At block 420, the first server 102 synchronizes the private key to the second server 104, as described below in connection with FIG. 6. The example instructions and/or operations of FIG. 4 end.

FIG. 5 is a flowchart representative of example machine readable instructions and/or example operations 500 that may be executed, instantiated, and/or performed by programmable circuitry to synchronize private key from the first server or global server 102 (FIG. 1A) to the second server or local server 104 (FIG. 1B). The example machine-readable instructions and/or the example operations 500 of FIG. 5 begin at block 502, at which the sync request monitor circuitry 302 (FIG. 3) monitors for synchronization requests from the first server or global server 102 (FIG. 1A). If the example sync request monitor circuitry 302 does not receive a sync request from the first server 102 (block 502: NO), control returns to the start, at which the example sync request monitor circuitry 302 continues to monitor for a sync request, or control advances to block 508, at which the example second server 104 generates a private key locally, as described below in connection with FIG. 9. If the example sync request monitor circuitry 302 detects a sync request (block 502: YES), control advances to block 504, at which the example second server 104 synchronize the second server private key with the private key from the first server 102, as described below in connection with FIG. 7. At block 506, the second server 104 delivers the private key to a gateway proxy 132 in example environment 100, as described below in connection with FIG. 8. The example instructions and/or operations of FIG. 5 end.

FIG. 6 is a flowchart representative of example machine readable instructions and/or example operations that may be executed, instantiated, and/or performed by example programmable circuitry to implement the first server 102 of FIG. 1A, and FIG. 2 to synchronize the private key from the first server 102 to the second server 104 (FIG. 1B). The instructions and/or operations represented in the flowchart of FIG. 6 may be used to implement block 420 of FIG. 4 to implement a synchronization process at the first server 102. The example machine-readable instructions and/or the example operations of FIG. 6 begin at block 602, at which the first server 102 creates a synchronization request custom resource (CR) in the example environment 100 (FIGS. 1A and 1B). At block 604, the communication interface circuitry 218 (FIG. 2) sends the synchronization request CR to the second server 104 and waits for an attestation CR with attestation result. If the example first server 102 does not receive an attestation CR update (block 606: NO), control advances to block 602, at which the example first server creates a synchronization request CR again. If the example first server 102 receives an attestation CR update (block 606: YES), control advances to block 608, at which the example key encryption circuitry 216 (FIG. 2) wraps or encrypts a user private key. At block 610, the example first server 102 updates the attestation CR with the wrapped or encrypted key. At block 612, the example communication interface circuitry 218 sends the attestation CR with the wrapped key to the second server 104. At block 614, the first server 102 sends a “delete synchronization request CR” to the second server 104. The example instructions and/or operations of FIG. 6 end.

FIG. 7 is a flowchart representative of example machine readable instructions and/or example operations that may be executed, instantiated, and/or performed by example programmable circuitry to implement the second server 104 of FIG. 1B, and FIG. 3 to synchronize the private key from the first server 102 (FIG. 1A) to the second server 104. The instructions and/or operations represented in the flowchart of FIG. 7 may be used to implement block 504 of FIG. 5 to implement a synchronization process at the second server 104. The example machine-readable instructions and/or the example operations of FIG. 7 begin at block 702, at which the example sync request monitor circuitry 302 (FIG. 3) monitors for synchronization requests from the first server or global server 102 (FIG. 1A). If the example sync request monitor circuitry 302 does not receive a sync request from the first server 102 (block 702: NO), control returns to the start, at which the example sync request monitor circuitry 302 continues to monitor for a sync request. If the example sync request monitor circuitry 302 detects a sync request (block 702: YES), control advances to block 704, at which the example quote generation circuitry 304 (FIG. 3) generates a quote and an example public and private key pair generation circuitry 306 (FIG. 3) generates a public and private key pair for remote attestation. At block 706, attestation CR controller circuitry 308 (FIG. 3) creates an attestation CR. At block 708, the example communication interface circuitry 310 (FIG. 3) receives an updated attestation CR with wrapped or encrypted user private key. At block 710, the example key decryption circuitry 312 (FIG. 3) decrypts or unwraps the user private key. At block 712, the second server 104 saves the user private key and certificate in the second server secure enclave or memory 142 (FIG. 1B). At block 714, the example second server 104 deletes the attestation CR. At block 716, the communication interface circuitry 310 receives “delete sync request CR” from the first server 102. The example instructions and/or operations of FIG. 7 end and control returns to block 506 of FIG. 5.

FIG. 8 is a flowchart representative of example machine readable instructions and/or example operations that may be executed, instantiated, and/or performed by example programmable circuitry to implement the second server 104 of FIG. 1B, and FIG. 3 to synchronize the private key from the second server 104 to the gateway proxy 132 (FIG. 1B) in example environment 100. The instructions and/or operations represented in the flowchart of FIG. 8 may be used to implement block 506 of FIG. 5 to deliver private keys from the second server 104 to a gateway proxy. The example machine-readable instructions and/or the example operations of FIG. 8 begin at block 802, at which the example communication interface circuitry 310 (FIG. 3) receives a secret discovery service (SDS) request from a gateway proxy 132. At block 804, the example attestation custom resource controller circuitry 308 (FIG. 3) sends an attestation request to the gateway proxy 132. At block 806, the example attestation custom resource controller circuitry 308 receives an attestation response from the gateway proxy 132. At block 808, the example attestation custom resource controller circuitry 308 creates an attestation CR for remote attestation. At block 810, the example attestation custom resource controller circuitry 308 receives an updated attestation CR. At block 812, the example key encryption circuitry 316 (FIG. 3) encrypts or wraps a related user private key to be sent to the gateway proxy 132. At block 814, the example attestation custom resource controller circuitry 308 deletes the attestation CR. At block 816, the communication interface circuitry 310 sends the wrapped user private key and the proxy configuration to the gateway proxy 132. At block 818, the example communication interface circuitry 310 sends an SDS response (private key provider) to the gateway proxy 132. The example instructions and/or operations of FIG. 8 end.

FIG. 9 is a flowchart representative of example machine readable instructions and/or example operations that may be executed, instantiated, and/or performed by example programmable circuitry to implement the second server 104 of FIG. 1B, and FIG. 3 to generate a private key locally at the second server 104. The instructions and/or operations represented in the flowchart of FIG. 9 may be used to implement block 508 of FIG. 5 to implement a key generation process at the second server 104. The example machine-readable instructions and/or the example operations of FIG. 9 begin at block 902, at which the example public and private key pair generation circuitry 306 (FIG. 3) generates a public and private key pair used in remote attestation process. At block 904, the example token file generation circuitry 318 generates a crypto API toolkit (CTK) token file. At block 906, the example quote generation circuitry 304 generates a quote for remote attestation. At block 908, the example CSR circuitry 307 generates a certificate service request (CSR) to a trusted certificate service or a certificate authority (CA) 122 (FIG. 1A). The example CSR circuitry 307 adds the quote as an extension in the CSR (block 910) for remote attestation. At block 912, the communication interface circuitry 310 receives a signed certificate after the remote attestation is successful. At block 914, the communication interface circuitry 310 sends proxy configurations and the certificate to the gateway proxy 132. The example instructions and/or operations of FIG. 9 end and control returns to block 506 of FIG. 5.

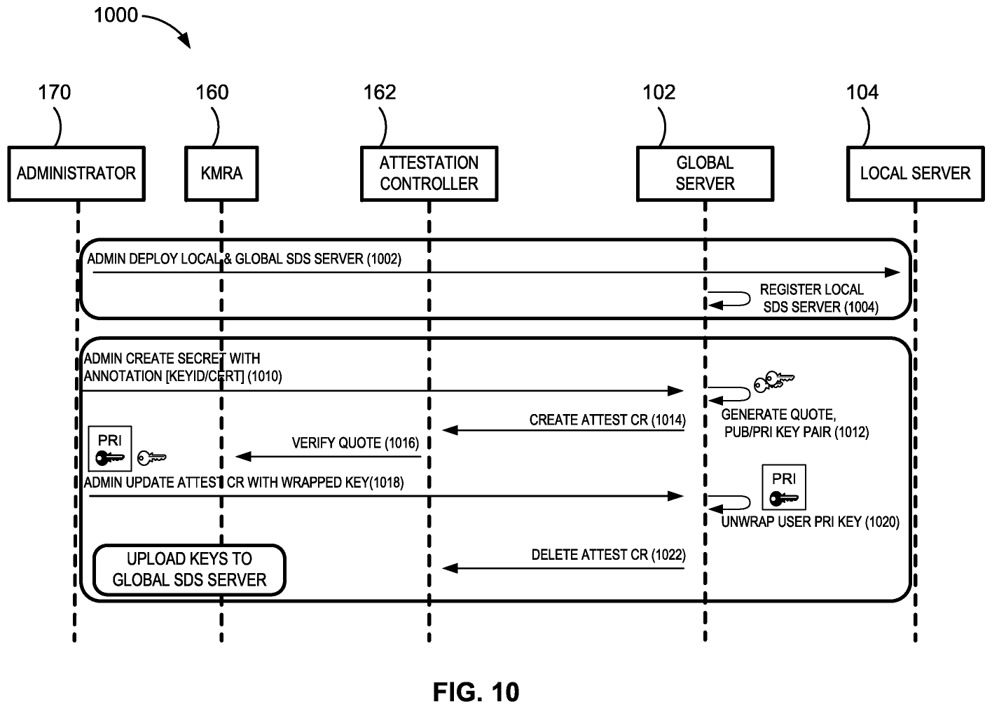

FIG. 10 is an interaction diagram of an example workflow 1000 to implement the example first server 102 of FIGS. 1A and 2, to upload keys to the first server 102 from an administrator 170 (FIG. 1A). Example FIG. 10 shows a process implemented by the administrator 170, key management reference application (KMRA) 160, attestation controller 162, first server or global server 102, and second server or local server 104 (FIG. 1B). In the illustrated example workflow 1000, at event 1002 the administrator 170 deploys a global server or first server 102, and a local server or a second server 104 in example environment 100. At event 1004, the example global server 102 registers the local server 104. At event 1010, the example administrator 170 creates a secret with annotation (e.g., key identifier (ID) or certificate) and sends it to the global server 102. At event 1012, the global server 102 generates a quote and public and private key pair for remote attestation. At event 1014, the global server 102 creates an attestation custom resource (CR) and sends the attestation CR to the example attestation controller 162. At event 1016, the example attestation controller 162 verifies the quote, remotely attesting the global server 102. At event 1018, the administrator 170 updates the attestation CR with the wrapped key. At event 1020, the global server 102 unwraps the user private key into its secure enclave 116 (FIG. 1A). At event 1022, the global server 102 deletes the attestation CR to the example attestation controller 162.

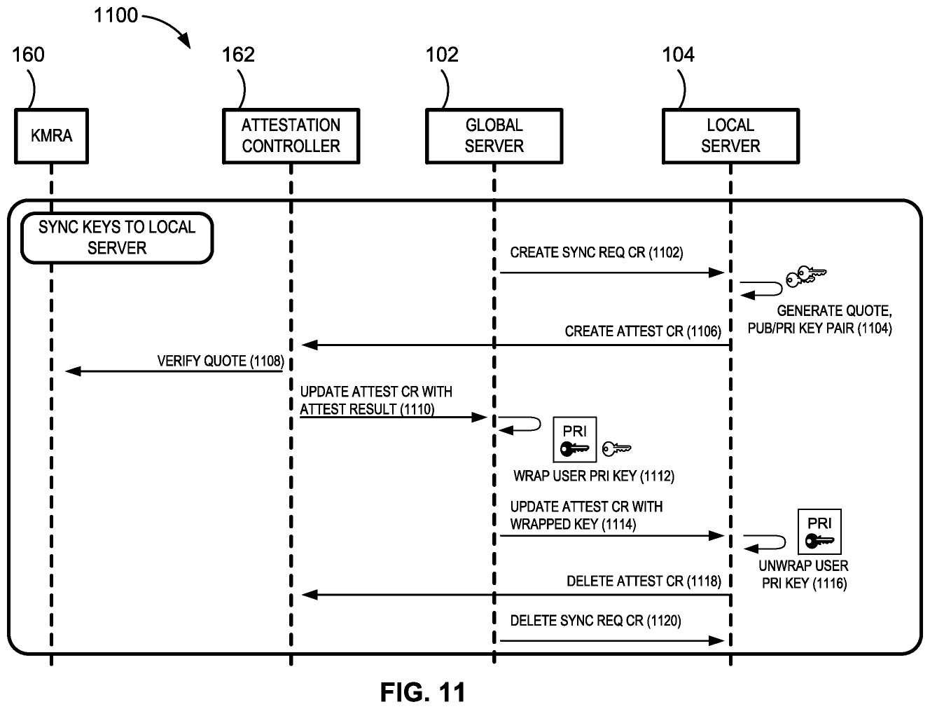

FIG. 11 is an interaction diagram of an example workflow 1100 to implement the example first server or global server 102 of FIGS. 1A and 2, and the example second server or local server 104 of FIGS. 1B and 3, to synchronize keys from the first server 102 to the second server 104. Example FIG. 11 shows a process implemented by the example key management reference application (KMRA) 160, the example attestation controller 162, first server or global server 102 (FIG. 1A), and second server or local server 104 (FIG. 1B). In the illustrated example workflow 1100, at event 1102 the global server 102 creates a synchronization request CR and sends it to the local server 104. At event 1104, the local server 104 generates a quote and public and private key pair for remote attestation. At event 1106, the local server 104 creates an attestation CR and sends it to the remote attestation controller 162 for remote attestation. At event 1108, the example attestation controller 162 verifies the quote and sends it to the example KMRA 160. At event 1110, the example attestation controller 162 updates the attestation CR with attestation results and sends them back to the global server 102. At event 1112, the global server 102 wraps or encrypts the user private key. At event 1114, the global server 102 updates the attestation CR with wrapped key and sends the wrapped key to the local server 104. At event 1116, the local server 104 unwraps the user private key. At event 1118, the local server 104 deletes the attestation CR request sent to the attestation controller. At event 1120, the global server 102 sends a delete synchronization request CR to the local server 104.

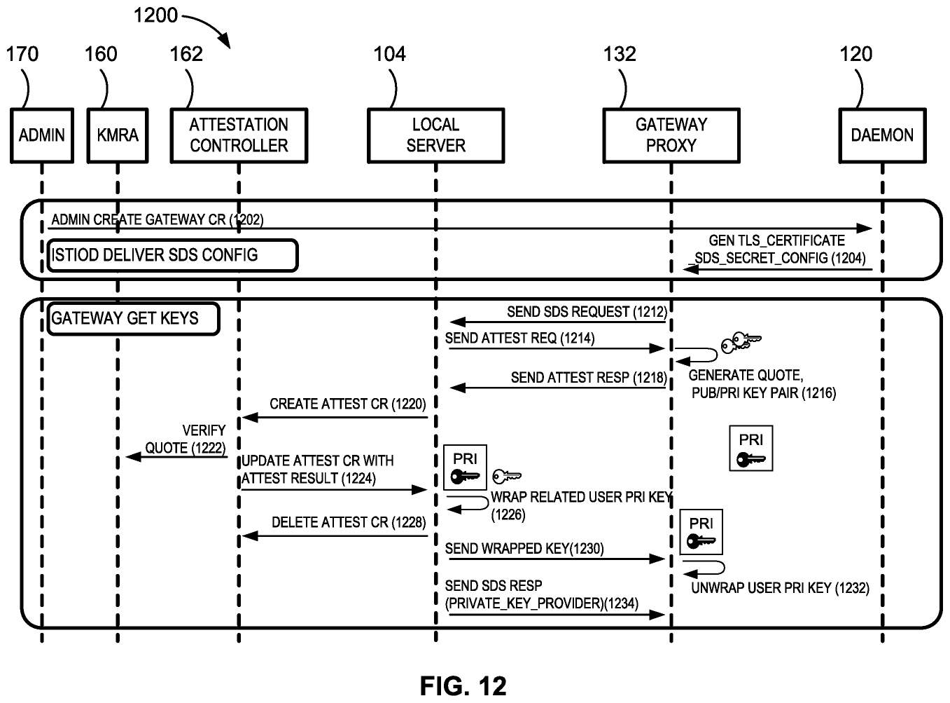

FIG. 12 is an interaction diagram of an example workflow 1200 to implement the example second server or local server 104 of FIGS. 1 and 3, to deliver keys from the local server 104 to a gateway proxy 132 (FIG. 1B). Example FIG. 12 shows a process implemented by the example administrator 170, the example key management reference application (KMRA) 160, the example attestation controller 162, second server or local server 104, the example gateway proxy 132, and the example daemon 120. In the illustrated example workflow 1200, at event 1202 the administrator 170 creates a gateway custom resource and sends it to the daemon 120. At event 1204, the daemon 120 generates a certificate “tls_certificate_sds_secret_config”. At event 1212, the example gateway proxy 132 sends a secret discovery service (SDS) request to the local server 104. At event 1214, the local server 104 responds by sending an attestation request to the gateway proxy 132. At event 1216, the gateway proxy 132 generates a quote, public and private key pair for remote attestation. At event 1218, the gateway proxy 132 sends the attestation response back to the local server 104. At event 1220, the local server 104 creates an attestation CR to the attestation controller 162. At event 1222, the attestation controller 162 verifies the quote from the gateway proxy 132 and sends the verified quote to the KMRA 160. At event 1224, the attestation controller 162 updates attestation CR with attestation result and sends the attestation results to the local server 104. At event 1226, the local server 104 wraps the related user private key. At event 1228, the local server 104 deletes the attestation CR sent to the attestation controller 162. At event 1230, the local server 104 sends the wrapped key to the gateway proxy 132. At event 1232, the gateway proxy 132 unwraps the user private key. At event 1234, the local server 104 sends a SDS response to the private key provider extension in the gateway proxy 132.

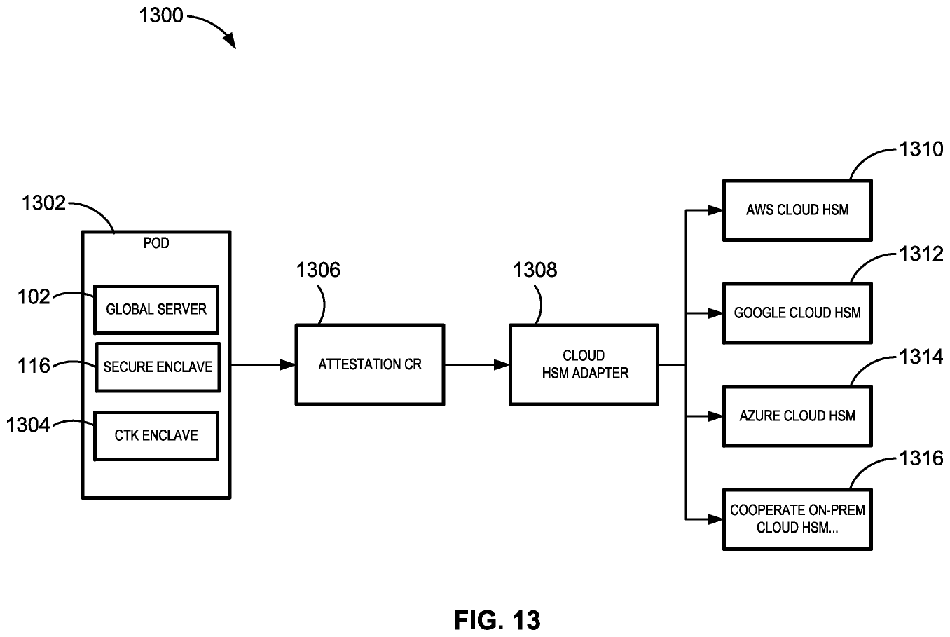

FIG. 13 is a block diagram illustrating the example first server of FIGS. 1A and 2 security policy and key delivery integration with cloud service provider (CSP) using the cloud hardware security module (HSM) adapter. In some examples, the cloud HSM adapter 1308 monitors the attestation CR 1306 to obtain a corresponding key identifier (ID) information and cloud HSM information. The example cloud HSM adapter 1308 establishes a secure call to the backend cloud HSM following corresponding cloud HSM API. The example cloud HSM adapter 1308 obtains the wrapped private keys from the cloud HSM 1320, 1312, 1314, and 1316 by updating the attestation CR 1306. The global server 102 unwraps the private keys into the global server secure enclave 116 by monitoring for updates from the attestation CR 1306.

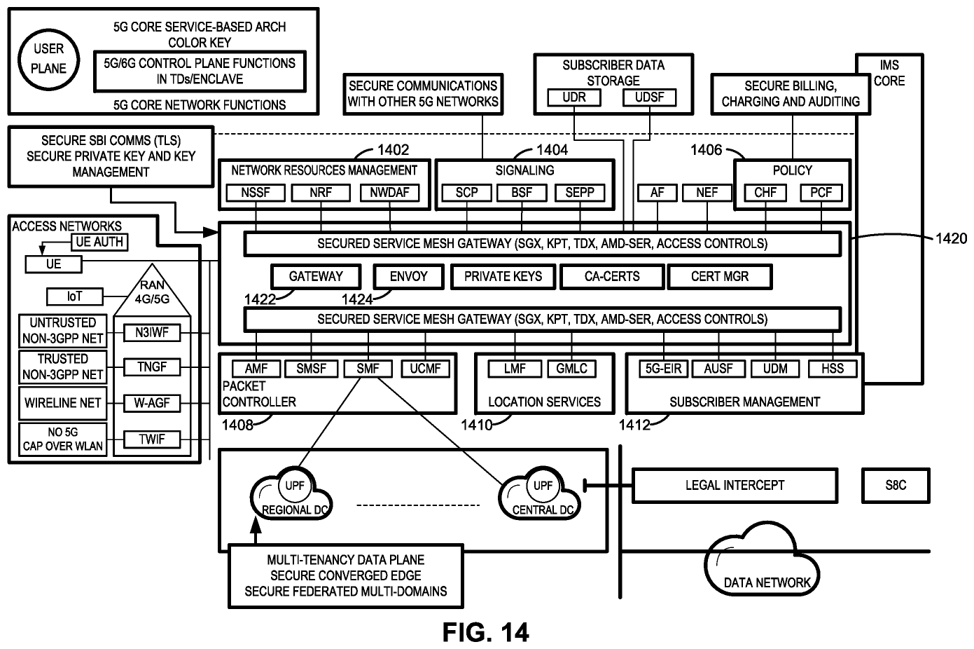

FIG. 14 is a block diagram illustrating the example first server of FIGS. 1A and 2 in a multi-tenant 5G control plane deployment using secured gateways with the example second server of FIGS. 1B and 3, according to some embodiments. In the example use case of FIG. 14, which shows a 5G use-case, the multiple 5G control plane functions 1402, 1404, 1406, 1408, 1410, and 1412 utilize a horizontal service mesh 1420 in a multi-tenancy and highly distributed deployments. All access to the example service mesh 1420 occurs through multiple instances of the gateway 1422 (e.g., ingress) which provides services to multiple tenants that require access to services offered by the 5G system. For example, a user may require 5G access like subscriber registration, billing, etc. These ingress points are able to meet the demands of the incoming traffic. Tenants securely access the service mesh through a cloud native API and hence, the gateway 1422 is a sensitive control point that protects the entry into the service mesh. The gateway 1422 protects security credentials of tenants through the use of hardware enforced security mechanism. The hardware enforced security mechanism increased the security of the service mesh.

FIG. 15 is a block diagram of an example programmable circuitry platform 1500 structured to execute and/or instantiate the example machine-readable instructions and/or the example operations of FIGS. 4, and 6 to implement the first server 102 of FIGS. 1, and 2. The programmable circuitry platform 1500 can be, for example, a server, a personal computer, a workstation, a self-learning machine (e.g., a neural network), an Internet appliance, or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, and/or microcontrollers from any desired family or manufacturer. The programmable circuitry 1512 may be implemented by one or more semiconductor based (e.g., silicon based) devices. In this example, the programmable circuitry 1512 implements the example local server monitor circuitry 202, the example registration circuitry 204, the example annotated secret monitor circuitry 206, the example quote generation circuitry 208, the example public and private key generation circuitry 210, the example attestation custom resource (CR) controller circuitry 212, the example key decryption circuitry 214, and the example key encryption circuitry 216.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1520 implements the communication interface circuitry 218 of FIG. 2.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1524 are also connected to the interface circuitry 1520 of the illustrated example. The output device(s) 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1532, which may be implemented by the machine readable instructions of FIGS. 4, and 6, may be stored in the mass storage device 1528, in the volatile memory 1514, in the non-volatile memory 1516, and/or on at least one non-transitory computer readable storage medium such as a CD or DVD which may be removable.

FIG. 16 is a block diagram of an example programmable circuitry platform 1600 structured to execute and/or instantiate the example machine-readable instructions and/or the example operations of FIG. 5, and 7-9 to implement the second server 104 of FIGS. 1, and 3. The programmable circuitry platform 1600 can be, for example, a server, a personal computer, a workstation, a self-learning machine (e.g., a neural network), an Internet appliance, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs, microprocessors, CPUs, GPUs, DSPs, and/or microcontrollers from any desired family or manufacturer. The programmable circuitry 1612 may be implemented by one or more semiconductor based (e.g., silicon based) devices. In this example, the programmable circuitry 1612 implements the example sync request monitor circuitry 302, the example quote generation circuitry 304, the example public and private key generation circuitry 306, the example attestation custom resource (CR) controller circuitry 308, the example key decryption circuitry 312, the example key encryption circuitry 316, and the example token file generation circuitry 318.

The programmable circuitry 1612 of the illustrated example includes a local memory 1613 (e.g., a cache, registers, etc.). The programmable circuitry 1612 of the illustrated example is in communication with main memory 1614, 1616, which includes a volatile memory 1614 and a non-volatile memory 1616, by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1620 implements the communication interface circuitry 310 of FIG. 3.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1600 of the illustrated example also includes one or more mass storage discs or devices 1628 to store firmware, software, and/or data. Examples of such mass storage discs or devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1632, which may be implemented by the machine readable instructions of FIGS. 5, and 7-9, may be stored in the mass storage device 1628, in the volatile memory 1614, in the non-volatile memory 1616, and/or on at least one non-transitory computer readable storage medium such as a CD or DVD which may be removable.

FIG. 17 is a block diagram of an example implementation of the programmable circuitry 1512 of FIG. 15. In this example, the programmable circuitry 1512 of FIG. 15 is implemented by a microprocessor 1700. For example, the microprocessor 1700 may be a general-purpose microprocessor (e.g., general-purpose microprocessor circuitry). The microprocessor 1700 executes some or all of the machine-readable instructions of the flowcharts of FIGS. 4, and 6 to effectively instantiate the circuitry of FIG. 2 as logic circuits to perform operations corresponding to those machine readable instructions. The microprocessor 1700 executes some or all of the machine-readable instructions of the flowcharts of FIGS. 5, and 7-9 to effectively instantiate the circuitry of FIG. 3 as logic circuits to perform operations corresponding to those machine readable instructions. In some such examples, the circuitry of FIGS. 2 and 3 is instantiated by the hardware circuits of the microprocessor 1700 in combination with the machine-readable instructions. For example, the microprocessor 1700 may be implemented by multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine readable instructions and/or operations represented by the flowcharts of FIGS. 4-9.

The cores 1702 may communicate by a first example bus 1704. In some examples, the first bus 1704 may be implemented by a communication bus to effectuate communication associated with one(s) of the cores 1702. For example, the first bus 1704 may be implemented by at least one of an Inter-Integrated Circuit (I2C) bus, a Serial Peripheral Interface (SPI) bus, a PCI bus, or a PCIe bus. Additionally or alternatively, the first bus 1704 may be implemented by any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2 cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1514, 1516 of FIG. 15 and the main memory 1614, 1616 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the local memory 1720, and a second example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating-point operations. In yet other examples, the AL circuitry 1716 may include first AL circuitry that performs integer-based operations and second AL circuitry that performs floating-point operations. In some examples, the AL circuitry 1716 may be referred to as an Arithmetic Logic Unit (ALU).

The registers 1718 are semiconductor-based structures to store data and/or instructions such as results of one or more of the operations performed by the AL circuitry 1716 of the corresponding core 1702. For example, the registers 1718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure, such as by being distributed throughout the core 1702 to shorten access time. The second bus 1722 may be implemented by at least one of an I2C bus, a SPI bus, a PCI bus, or a PCIe bus.

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages.

The microprocessor 1700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1700, in the same chip package as the microprocessor 1700 and/or in one or more separate packages from the microprocessor 1700.

FIG. 18 is a block diagram of another example implementation of the programmable circuitry 1512 of FIG. 15 and the programmable circuitry 1612 of FIG. 16. In this example, the programmable circuitry 1512 and 1612 are implemented by FPGA circuitry 1800. For example, the FPGA circuitry 1800 may be implemented by an FPGA. The FPGA circuitry 1800 can be used, for example, to perform operations that could otherwise be performed by the example microprocessor 1700 of FIG. 17 executing corresponding machine readable instructions. However, once configured, the FPGA circuitry 1800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1700 of FIG. 17 described above (which is a general purpose device that may be programmed to execute some or all of the machine readable instructions represented by the flowchart(s) of FIGS. 4-9 but whose interconnections and logic circuitry are fixed once fabricated), the FPGA circuitry 1800 of the example of FIG. 18 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-9. In particular, the FPGA circuitry 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-9. As such, the FPGA circuitry 1800 may be configured and/or structured to effectively instantiate some or all of the operations/functions corresponding to the machine readable instructions of the flowchart(s) of FIGS. 4-9 as dedicated logic circuits to perform the operations/functions corresponding to those software instructions in a dedicated manner analogous to an ASIC. Therefore, the FPGA circuitry 1800 may perform the operations/functions corresponding to the some or all of the machine readable instructions of FIGS. 4-9 faster than the general-purpose microprocessor can execute the same.

In the example of FIG. 18, the FPGA circuitry 1800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

The FPGA circuitry 1800 of FIG. 18, includes example input/output (I/O) circuitry 1802 to obtain and/or output data to/from example configuration circuitry 1804 and/or external hardware 1806. For example, the configuration circuitry 1804 may be implemented by interface circuitry that may obtain a binary file, which may be implemented by a bit stream, data, and/or machine-readable instructions, to configure the FPGA circuitry 1800, or portion(s) thereof. In some such examples, the configuration circuitry 1804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1806 may be implemented by external hardware circuitry. For example, the external hardware 1806 may be implemented by the microprocessor 1700 of FIG. 17.

The FPGA circuitry 1800 also includes an array of example logic gate circuitry 1808, a plurality of example configurable interconnections 1810, and example storage circuitry 1812. The logic gate circuitry 1808 and the configurable interconnections 1810 are configurable to instantiate one or more operations/functions that may correspond to at least some of the machine readable instructions of FIGS. 4-9 and/or other desired operations. The logic gate circuitry 1808 shown in FIG. 18 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations/functions. The logic gate circuitry 1808 may include other electrical structures such as look-up tables (LUTs), registers (e.g., flip-flops or latches), multiplexers, etc.

The configurable interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example dedicated operations circuitry 1814. In this example, the dedicated operations circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the programmable circuitry 1512 of FIG. 15 and 1612 of FIG. 16, many other approaches are contemplated. For example, FPGA circuitry may include an on-board CPU, such as one or more of the example CPU 1820 of FIG. 17. Therefore, the programmable circuitry 1512 of FIG. 15 and 1612 of FIG. 16 may additionally be implemented by combining at least the example microprocessor 1700 of FIG. 17 and the example FPGA circuitry 1800 of FIG. 18. In some such hybrid examples, one or more cores 1702 of FIG. 17 may execute a first portion of the machine readable instructions represented by the flowchart(s) of FIGS. 4-9 to perform first operation(s)/function(s), the FPGA circuitry 1800 of FIG. 18 may be configured and/or structured to perform second operation(s)/function(s) corresponding to a second portion of the machine readable instructions represented by the flowcharts of FIG. 4-9, and/or an ASIC may be configured and/or structured to perform third operation(s)/function(s) corresponding to a third portion of the machine readable instructions represented by the flowcharts of FIGS. 4-9].

It should be understood that some or all of the circuitry of FIGS. 2 and 3 may, thus, be instantiated at the same or different times. For example, same and/or different portion(s) of the microprocessor 1700 of FIG. 17 may be programmed to execute portion(s) of machine-readable instructions at the same and/or different times. In some examples, same and/or different portion(s) of the FPGA circuitry 1800 of FIG. 18 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 1700 of FIG. 17 may execute machine readable instructions in one or more threads executing concurrently and/or in series. In some examples, the FPGA circuitry 1800 of FIG. 18 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 1700 of FIG. 17.

In some examples, the programmable circuitry 1512 of FIG. 15 and 1612 of FIG. 16 may be in one or more packages. For example, the microprocessor 1700 of FIG. 17 and/or the FPGA circuitry 1800 of FIG. 18 may be in one or more packages. In some examples, an XPU may be implemented by the programmable circuitry 1512 of FIG. 15 and 1612 of FIG. 16, which may be in one or more packages. For example, the XPU may include a CPU (e.g., the microprocessor 1700 of FIG. 17, the CPU 1820 of FIG. 18, etc.) in one package, a DSP (e.g., the DSP 1822 of FIG. 18) in another package, a GPU in yet another package, and an FPGA (e.g., the FPGA circuitry 1800 of FIG. 18) in still yet another package.

A block diagram illustrating an example software distribution platform 1905 to distribute software such as the example machine readable instructions 1532 of FIG. 15 and 1632 of FIG. 16 to other hardware devices (e.g., hardware devices owned and/or operated by third parties from the owner and/or operator of the software distribution platform) is illustrated in FIG. 1919. The example software distribution platform 1905 may be implemented by any computer server, data facility, cloud service, etc., capable of storing and transmitting software to other computing devices. The third parties may be customers of the entity owning and/or operating the software distribution platform 1905. For example, the entity that owns and/or operates the software distribution platform 1905 may be a developer, a seller, and/or a licensor of software such as the example machine readable instructions 1532 of FIG. 15 and 1632 of FIG. 16. The third parties may be consumers, users, retailers, OEMs, etc., who purchase and/or license the software for use and/or re-sale and/or sub-licensing. In the illustrated example, the software distribution platform 1905 includes one or more servers and one or more storage devices. The storage devices store the machine readable instructions 1532, which may correspond to the example machine readable instructions of FIGS. 4, and 6, as described above. The storage devices store the machine readable instructions 1632, which may correspond to the example machine readable instructions of FIGS. 5, and 7-9, as described above. The one or more servers of the example software distribution platform 1905 are in communication with an example network 1910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 and 1632 from the software distribution platform 1905. For example, the software, which may correspond to the example machine readable instructions of FIGS. 4, and 6, may be downloaded to the example programmable circuitry platform 1500, which is to execute the machine readable instructions 1532 to implement the first server 102. For example, the software, which may correspond to the example machine readable instructions of FIGS. 5, and 7-9, may be downloaded to the example programmable circuitry platform 1600, which is to execute the machine readable instructions 1632 to implement the second server 104. In some examples, one or more servers of the software distribution platform 1905 periodically offer, transmit, and/or force updates to the software (e.g., the example machine readable instructions 1532 of FIG. 15 and 1632 of FIG. 16) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that provides hardware enforced security for service mesh key management. Disclosed systems, apparatus, articles of manufacture, and methods improve the efficiency of using a computing device by providing hardware enforced security for service mesh key management. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to provide hardware enforced security for service mesh key management are disclosed herein. Further examples and combinations thereof include the following: Example 1 includes a first server of a service mesh comprising interface circuitry, machine-readable instructions, and programmable circuitry to at least one of instantiate or execute the machine-readable instructions to detect a second server of the service mesh, cause a public key of the second server to be stored in a first enclave, and after an attestation for a second enclave is obtained, cause addition of the second server to the service mesh.

Example 2 includes a first server of a service mesh of example 1, wherein the first server is on a control plane of the service mesh.

Example 3 includes a first server of a service mesh of example 2, wherein the service mesh is to control delivery of service requests through the control plane that creates service instances, exchanges policy and telemetry information with a proxy on a data plane.

Example 4 includes a first server of a service mesh of example 1, wherein the programmable circuitry is to cause the first server to request an attestation for the first enclave.

Example 5 includes a first server of a service mesh of example 1, wherein the programmable circuitry is to generate a cryptographic measurement of the first enclave.

Example 6 includes a first server of a service mesh of example 5, wherein the programmable circuitry is to cause transmission of the cryptographic measurement to an attestation controller to verify the cryptographic measurement of the first enclave.

Example 7 includes a first server of a service mesh of example 1, wherein the programmable circuitry is to cause transmission of a key pair from the first server to a key manager to verify an identity of the first server.

Example 8 includes a first server of a service mesh of example 1, wherein the programmable circuitry is to encrypt a private key with the public key of the second server and the second server is to deliver an encrypted private key from the first server to a proxy on a gateway of the service mesh.

Example 9 includes a non-transitory machine readable storage medium comprising instructions to cause programmable circuitry to at least detect a server of a service mesh, cause a public key of the server to be stored in a first enclave, and after an attestation for a second enclave is obtained, cause addition of the server to the service mesh.

Example 10 includes a non-transitory machine readable storage medium of example 9, wherein a first server is on a control plane of the service mesh.

Example 11 includes a non-transitory machine readable medium of example 9, wherein a second server is on a data plane of the service mesh.

Example 12 includes a non-transitory machine readable storage medium of example 10, wherein the instructions are to cause the programmable circuitry to cause the first server to request an attestation for the first enclave.

Example 13 includes a non-transitory machine readable storage medium of example 10, the instructions are to cause the programmable circuitry to generate a cryptographic measurement of the first enclave.

Example 14 includes a non-transitory machine readable storage medium of example 13, wherein the instructions are to cause the programmable circuitry to cause transmission of the cryptographic measurement to an attestation controller to verify the cryptographic measurement of the first enclave.

Example 15 includes a non-transitory machine readable storage medium of example 9, wherein the instructions are to cause the programmable circuitry to encrypt a private key with the public key of the second server and a first server is to deliver an encrypted private key to a proxy on a gateway of the service mesh via a second server.

Example 16 includes a method comprising detecting, with programmable circuitry, a server of a service mesh, causing a public key of the server to be stored in a first enclave, and after an attestation for a second enclave is obtained, causing addition of the server to the service mesh.

Example 17 includes a method of example 16, wherein a first server is on a control plane of the service mesh.

Example 18 includes a method of example 17, wherein the service mesh is to control delivery of service requests through the control plane that creates service instances, exchanges policy and telemetry information with a proxy on a data plane.

Example 19 includes a method of example 16, wherein a second server is on a data plane of the service mesh.

Example 20 includes a method of example 16, further including generating a cryptographic measurement of the first enclave.

Example 21 includes a method of example 20, further including causing transmission of the cryptographic measurement to an attestation controller to verify the cryptographic measurement of the first enclave.

Example 22 includes a method of example 16, wherein a second server is to deliver an encrypted private key to a proxy on a gateway of the service mesh.

It is noted that this patent claims priority from the national stage of International Application No. PCT/CN2023/098861, which was filed on Jun. 7, 2023, and is hereby incorporated by reference in its entirety.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A first server of a service mesh comprising:
interface circuitry;
machine-readable instructions; and
programmable circuitry to at least one of instantiate or execute the machine-readable instructions to:
detect a second server of the service mesh;
cause a public key of the second server to be stored in a first enclave; and
after an attestation for a second enclave is obtained, cause addition of the second server to the service mesh.

2. A first server of a service mesh of claim 1, wherein the first server is on a control plane of the service mesh.

3. A first server of a service mesh of claim 2, wherein the service mesh is to control delivery of service requests through the control plane that creates service instances, exchanges policy and telemetry information with a proxy on a data plane.

4. A first server of a service mesh of claim 1, wherein the programmable circuitry is to cause the first server to request an attestation for the first enclave.

5. A first server of a service mesh of claim 1, wherein the programmable circuitry is to generate a cryptographic measurement of the first enclave.

6. A first server of a service mesh of claim 5, wherein the programmable circuitry is to cause transmission of the cryptographic measurement to an attestation controller to verify the cryptographic measurement of the first enclave.

7. A first server of a service mesh of claim 1, wherein the programmable circuitry is to cause transmission of a key pair from the first server to a key manager to verify an identity of the first server.

8. A first server of a service mesh of claim 1, wherein the programmable circuitry is to encrypt a private key with the public key of the second server and the second server is to deliver an encrypted private key from the first server to a proxy on a gateway of the service mesh.

9. A non-transitory machine readable storage medium comprising instructions to cause programmable circuitry to at least:
detect a server of a service mesh;
cause a public key of the server to be stored in a first enclave; and
after an attestation for a second enclave is obtained, cause addition of the server to the service mesh.

10. A non-transitory machine readable storage medium of claim 9, wherein a first server is on a control plane of the service mesh.

11. A non-transitory machine readable medium of claim 9, wherein a second server is on a data plane of the service mesh.

12. A non-transitory machine readable storage medium of claim 10, wherein the instructions are to cause the programmable circuitry to cause the first server to request an attestation for the first enclave.

13. A non-transitory machine readable storage medium of claim 10, the instructions are to cause the programmable circuitry to generate a cryptographic measurement of the first enclave.

14. A non-transitory machine readable storage medium of claim 13, wherein the instructions are to cause the programmable circuitry to cause transmission of the cryptographic measurement to an attestation controller to verify the cryptographic measurement of the first enclave.

15. A non-transitory machine readable storage medium of claim 9, wherein the instructions are to cause the programmable circuitry to encrypt a private key with the public key of the second server and a first server is to deliver an encrypted private key to a proxy on a gateway of the service mesh via a second server.

16. A method comprising:
detecting, with programmable circuitry, a server of a service mesh;
causing a public key of the server to be stored in a first enclave; and
after an attestation for a second enclave is obtained, causing addition of the server to the service mesh.

17. A method of claim 16, wherein a first server is on a control plane of the service mesh.

18. (canceled)

19. A method of claim 16, wherein a second server is on a data plane of the service mesh.

20. A method of claim 16, further including generating a cryptographic measurement of the first enclave.

21. (canceled)

22. A method of claim 16, wherein a second server is to deliver an encrypted private key to a proxy on a gateway of the service mesh.
